(19) United States
(12) Patent Application Publication
(10) Pub. No.: US 2017/0313793 A1
(43) Pub. Date: Nov. 2, 2017

(54) CATALYSTS

(71) Applicant: SCG CHEMICALS CO., LTD., Bangsue Bangkok (TH)

(72) Inventors: Dermot O'HARE, Oxford (GB); Jean-Charles BUFFET, Oxford (GB); Tossapol KHAMNAEN, Bangsue Bangkok (TH)

(21) Appl. No.: 15/526,176

(22) PCT Filed: Nov. 13, 2015
(86) PCT No.: PCT/GB2015/053457

§ 371 Date: May 11, 2017

(30) Foreign Application Priority Data
Nov. 13, 2014 (GB) 1420214.7
Oct. 1, 2015 (GB) 1517384.2

(51) Int. Cl. C08F 10/02; C07F 17/00

(52) U.S. Cl. CPC C08F 10/02; C07F 17/00

(57) ABSTRACT

Novel catalytic compositions are disclosed comprising novel unsymmetrical metallocene catalytic compounds. Also disclosed are uses of such catalytic compositions in olefin polymerisation reactions, as well as processes of polymerising olefins. When compared with the prior art compositions, the catalytic compositions of the invention are markedly more active in the polymerisation of olefins.

### INTRODUCTION

The present invention relates to catalysts. More specifically, the present invention relates to particular metallocene catalysts, and the use of such catalysts in polyolefin polymerization reactions. Even more specifically, the present invention relates to unsymmetrical metallocene catalysts, and the use of such catalysts in ethylene polymerization reactions.

### BACKGROUND OF THE INVENTION

It is well known that ethylene (and α-olefins in general) can be readily polymerized at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

It is also well known that these η⁵-cyclopentadienyl type ligands can be modified in a myriad of ways. One particular modification involves the introduction of a linking group between the two cyclopentadienyl rings to form ansa-metallocenes.

Numerous ansa-metallocenes of transition metals are known in the art. However, there remains a need for improved ansa-metallocene catalysts for use in polyolefin polymerization reactions. In particular, there remains a need for new metallocene catalysts with high polymerization activities/efficiencies.

There is also a need for catalysts that can produce polyethylenes with particular characteristics. For example, catalysts capable of producing linear high density polyethylene (LHDPE) with a relatively narrow dispersion in polymer chain length are desirable. Moreover, there is a need for catalysts that can produce polyethylene copolymers having good co-monomer incorporation and good intermolecular uniformity of polymer properties.

WO2011/051705 discloses ansa-metallocene catalysts based on two η⁵-indenyl ligands linked via an ethylene group.

There remains a need for ansa-metallocene catalysts having improved polymerization activity. Moreover, due to the high value that industry places on such materials, there is also a need for ansa-metallocene catalysts capable of polymerizing α-olefins to high molecular weights, without compromising polydispersity. It is even further desirable that such catalysts can be easily synthesized.

The present invention was devised with the foregoing in mind.

### SUMMARY OF THE INVENTION

According to a first aspect of the present invention there is provided a composition comprising a solid methyl aluminoxane support material and a compound of formula (I) defined herein.

According to a second aspect of the present invention, there is provided a use of a composition as defined herein as a polymerisation catalyst for the preparation of a polyethylene homopolymer or a copolymer comprising polyethylene.

According to a third aspect of the present invention, there is provided a process for forming a polyethylene homopolymer or a polyethylene copolymer which comprises reacting olefin monomers in the presence of a composition as defined herein.

### DETAILED DESCRIPTION OF THE INVENTION

### Definitions

The term “alkyl” as used herein includes reference to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl (including neopentyl), hexyl and the like. In particular, an alkyl may have 1, 2, 3 or 4 carbon atoms.

The term “alkenyl” as used herein include reference to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein include reference to straight or branched chain alkynyl moieties, typically having 2, 3, 4, 5 or 6 carbon atoms. The term includes reference to alkynyl moieties containing 1, 2 or 3 carbon-carbon triple bonds (C≡O). This term includes reference to groups such as ethynyl, propynyl, butynyl, pentynyl and hexynyl.

The term “alkoxy” as used herein include reference to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” as used herein includes reference to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “carbocyclyl” as used herein includes reference to an alicyclic moiety having 3, 4, 5, 6, 7 or 8 carbon atoms. The group may be a bridged or polycyclic ring system. More often cycloalkyl groups are monocyclic. This term includes reference to groups such as cyclopropyl, cyclobutyl, cyclopentyl, cyclohexyl, norbornyl, bicyclo[2.2.2]octyl and the like.

The term “heterocyclyl” as used herein includes reference to a saturated (e.g. heterocycloalkyl) or unsaturated (e.g. heteroaryl) heterocyclic ring moiety having from 3, 4, 5, 6, 7, 8, 9 or 10 ring atoms, at least one of which is selected from nitrogen, oxygen, phosphorus, silicon and sulphur. In particular, heterocyclyl includes a 3- to 10-membered ring or ring system and more particularly a 5- or 6-membered ring, which may be saturated or unsaturated.

A heterocyclic moiety is, for example, selected from oxiranyl, azirinyl, 1,2-oxathiolanyl, imidazolyl, thienyl, furyl, tetrahydrofuryl, pyranyl, thiopyranyl, thianthrenyl, iso-benzofuranyl, benzofuranyl, chromenyl, 2H-pyrrolyl, pyrrolyl, pyrrolinyl, pyrrolidinyl, imidazolyl, imidazolidinyl, benzimidazolyl, pyrazolyl, pyrazinyl, pyrazolidinyl, thiazolyl, isothiazolyl, dithiazolyl, oxazolyl, isoxazolyl, pyridyl, pyrazinyl, pyrimidinyl, piperidyl, piperazinyl, pyridazinyl, morpholinyl, thiomorpholinyl, especially thiomorpholino, indolizinyl, isoindolyl, 3H-indolyl, indolyl, benzimidazolyl, cumaryl, indazolyl, triazolyl, tetrazolyl, purinyl, 4H-quinolizinyl, isoquinolyl, quinolyl, tetrahydroquinolyl, tetrahydroisoquinolyl, decahydroquinolyl, octahydroisoquinolyl, benzofuranyl, dibenzofuranyl, benzothiophenyl, dibenzothiophenyl, phthalazinyl, naphthyridinyl, quinoxalyl, quinazolinyl, quinazolinyl, cinnolinyl, pteridinyl, carbazolyl, β-carbolinyl, phenanthridinyl, acridinyl, perimidinyl, phenanthrolinyl, furazanyl, phenazinyl, phenothiazinyl, phenoxazinyl, chromenyl, isochromanyl, chromanyl and the like.

The term “heteroaryl” as used herein includes reference to an aromatic heterocyclic ring system having 5, 6, 7, 8, 9 or 10 ring atoms, at least one of which is selected from nitrogen, oxygen and sulphur. The group may be a polycyclic ring system, having two or more rings, at least one of which is aromatic, but is more often monocyclic. This term includes reference to groups such as pyrimidinyl, furanyl, benzo[b]thiophenyl, thiophenyl, pyrrolyl, imidazolyl, pyrrolidinyl, pyridinyl, benzo[b]furanyl, pyrazinyl, purinyl, indolyl, benzimidazolyl, quinolinyl, phenothiazinyl, triazinyl, phthalazinyl, 2H-chromenyl, oxazolyl, isoxazolyl, thiazolyl, isoindolyl, indazolyl, purinyl, isoquinolinyl, quinazolinyl, pteridinyl and the like.

The term “halogen” or “halo” as used herein includes reference to F, Cl, Br or I. In a particular, halogen may be F or Cl, of which Cl is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

### Catalytic Compositions

As discussed hereinbefore, the present invention provides a composition comprising a solid methyl aluminoxane support material and a compound of the formula (I) shown below:

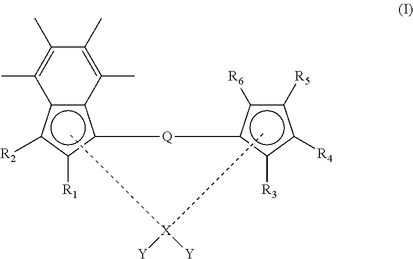

wherein:

R₁ and R₂ are each independently (1-2C)alkyl;

R₃ and R₄ are each independently hydrogen or (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

R₅ and R₆ are each independently hydrogen or (1-4C)alkyl, or R₅ and R₆ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

Q is a bridging group comprising 1, 2 or 3 bridging atoms selected from C, N, O, S, Ge, Sn, P, B, or Si, or a combination thereof, and is optionally substituted with one or more groups selected from hydroxyl, (1-6C)alkyl, (2-6C)alkenyl, (2-6C)alkynyl, (1-6C)alkoxy and aryl;

X is selected from zirconium, titanium or hafnium; and

each Y group is independently selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, —C(O)NRₓR_{y} or Si[(1-4C)alkyl]₃;
wherein Rₓ and R_{y} are independently (1-4C)alkyl;

with the proviso that:
i) when R₃ and R₄ are hydrogen or (1-4C)alkyl, R₅ and R₆ are not linked to form a fused 6-membered aromatic ring that is substituted with four methyl groups; and
ii) when R₅ and R₆ are hydrogen or (1-4C)alkyl, R₃ and R₄ are not linked to form a fused 6-membered aromatic ring that is substituted with four methyl groups.

In an embodiment, the compound has a structure according to formula (I) wherein

R₁ and R₂ are each independently (1-2C)alkyl;

R₃ and R₄ are each independently hydrogen or (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

R₅ and R₆ are each independently hydrogen or (1-4C)alkyl, or R₅ and R₆ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

Q is a bridging group comprising 1, 2 or 3 bridging atoms selected from C, N, O, S, Ge, Sn, P, B, or Si, or a combination thereof, and is optionally substituted with one or more groups selected from hydroxyl, (1-6C)alkyl, (2-6C)alkenyl, (2-6C)alkynyl, (1-6C)alkoxy and aryl;

X is selected from zirconium, titanium or hafnium; and

each Y group is independently selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with halo, nitro, amino, phenyl, —C(O)NRₓR_{y}, (1-6C)alkoxy, or Si[(1-4C)alkyl]₃;
wherein Rₓ and R_{y} are independently (1-4C)alkyl;

with the proviso that:
i) when R₃ and R₄ are hydrogen or (1-4C)alkyl, R₅ and R₆ are not linked to form a fused 6-membered aromatic ring that is substituted with four methyl groups; and
ii) when R₅ and R₆ are hydrogen or (1-4C)alkyl, R₃ and R₄ are not linked to form a fused 6-membered aromatic ring that is substituted with four methyl groups.

In another embodiment, the compound has a structure according to formula (I) wherein

R₁ and R₂ are each independently (1-2C)alkyl;

R₃ and R₄ are each independently hydrogen or (1-4C)alkyl, or R₃ and R₄ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

R₅ and R₆ are each independently hydrogen or (1-4C)alkyl, or R₅ and R₆ are linked such that, when taken in combination with the atoms to which they are attached, they form a 6-membered fused aromatic ring optionally substituted with one or more groups selected from (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;

Q is a bridging group comprising 1, 2 or 3 bridging atoms selected from C, N, O, S, Ge, Sn, P, B, or Si, or a combination thereof, and is optionally substituted with one or more groups selected from hydroxyl, (1-6C)alkyl, (2-6C)alkenyl, (2-6C)alkynyl, (1-6C)alkoxy and aryl;

X is selected from zirconium, titanium or hafnium; and

at least one Y group is an aryloxy group which is optionally substituted with one or more groups selected from (1-6C)alkyl, and the other Y group is independently selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, —C(O)NRₓR_{y}, (1-6C)alkoxy, or Si[(1-4C)alkyl]₃;
wherein Rₓ and R_{y} are independently (1-4C)alkyl;

with the proviso that:
i) when R₃ and R₄ are hydrogen or (1-4C)alkyl, R₅ and R₆ are not linked to form a fused 6-membered aromatic ring that is substituted with four methyl groups; and
ii) when R₅ and R₆ are hydrogen or (1-4C)alkyl, R₃ and R₄ are not linked to form a fused 6-membered aromatic ring that is substituted with four methyl groups.

Having regard to the proviso outlined above, it will be understood that the particular motifs not covered by the scope of the appended claims are as follows:

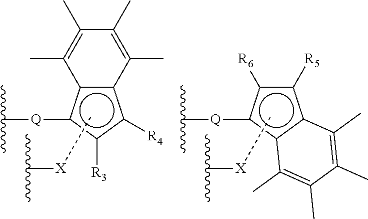

It will be appreciated that the structural formula (I) presented above is intended to show the substituent groups in a clear manner. A more representative illustration of the spatial arrangement of the groups is shown in the alternative representation below:

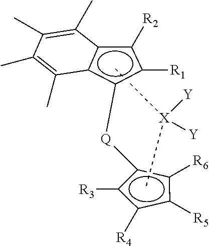

It will also be appreciated that when substituents R₃ and R₄ are not identical to substituents R₅ and R₆ respectively, the compounds of the present invention may be present as meso or rac isomers, and the present invention includes both such isomeric forms. A person skilled in the art will appreciate that a mixture of isomers of the compound of formula (I) may be used for catalysis applications, or the isomers may be separated and used individually (using techniques well known in the art, such as, for example, fractional crystallization).

The compositions of the invention exhibit superior catalytic performance when compared with current metallocene compounds/compositions used in the polymerisation of α-olefins. In particular, when compared with analogous silica-supported methyl aluminoxane (SSMAO) and layered double hydroxide-supported methyl aluminoxane (LDHMAO) catalyst compositions, the solid MAO compositions of the invention exhibit significantly increased catalytic activity in the homopolymerisation and copolymerisation of α-olefins. Moreover, polymers produced by α-olefin polymerization in the presence of compositions of the invention are typically of a higher molecular weight than polymers prepared using other catalysts, without an attendant increase in polydispersity. Such materials are highly valued by industry. Furthermore, polyethylene copolymers produced by α-olefin polymerization in the presence of compositions of the invention demonstrate good co-monomer incorporation in polyethylene, with good inter-molecular uniformity.

Solid methyl aluminoxane (MAO) (often referred to as polymethylaluminoxane) is distinguished from other methyl aluminoxanes (MAOs) as it is insoluble in hydrocarbon solvents and so acts as a heterogeneous support system. Any suitable solid MAO support may be used.

In an embodiment, the solid MAO support is insoluble in toluene and hexane.

In another embodiment, the solid MAO support is in particulate form. Suitably, the particles of the solid MAO support are spherical, or substantially spherical, in shape.

In a particularly suitable embodiment, the solid MAO support is as described in US2013/0059990 and obtainable from Tosoh Finechem Corporation, Japan.

In an embodiment, the solid MAO support is prepared according to the following protocol:

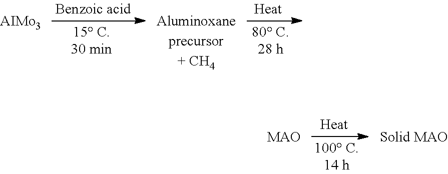

The properties of the solid MAO support can be adjusted by altering one or more of the processing variables used during its synthesis. For example, in the above-outlined protocol, the properties of the solid MAO support may be adjusted by varying the Al:O ratio, by fixing the amount of AlMe₃ and varying the amount of benzoic acid. Exemplary Al:O ratios are 1:1, 1.1:1, 1.2:1, 1.3:1, 1.4:1 and 1.6:1. Suitably the Al:O ratio is 1.2:1 or 1.3:1. Alternatively, the properties of the solid MAO support may be adjusted by fixing the amount of benzoic acid and varying the amount of AlMe₃.

In another embodiment, the solid MAO support is prepared according to the following protocol:

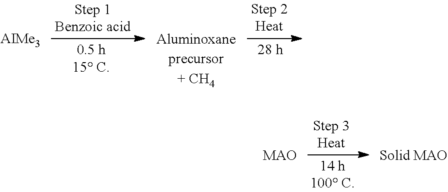

In the above protocol, steps 1 and 2 may be kept constant, with step 2 being varied. The temperature of step 2 may be 70-100° C. (e.g. 70° C., 80° C., 90° C. or 100° C.). The duration of step 2 may be from 12 to 28 hours (e.g. 12, 20 or 28 hours).

The compound of formula (I) may be immobilized on the solid MAO support by one or more ionic or covalent interactions.

In an embodiment, the composition further comprises one or more suitable activators. Suitable activators are well known in the art and include organo aluminium compounds (e.g. alkyl aluminium compounds). Particularly suitable activators include aluminoxanes (e.g. methylaluminoxane (MAO)), triisobutylaluminium (TIBA), diethylaluminium (DEAC) and triethylaluminium (TEA).

In another embodiment, the solid MAO support comprises additional compound selected from M(C₆F₅)₃, wherein M is aluminium or boron, or M′R₂, wherein M′ is zirconium or magnesium and R is (1-10C)alkyl (e.g. methyl or octyl).

In an embodiment, R₃ and R₄ are each independently hydrogen or (1-4C)alkyl, or R₃ and R₄ are linked such that, when taken in combination with the atoms to which they are attached, they form a fused 6-membered aromatic ring optionally substituted with one or more groups selected from (1-4C)alkyl, (2-4C)alkenyl, (2-4C)alkynyl, (1-4C)alkoxy, aryl, heteroaryl, carbocyclic and heterocyclic, wherein each aryl, heteroaryl, carbocyclic and heterocyclic group is optionally substituted with one or more groups selected from (1-4C)alkyl, (2-4C)alkenyl, (2-4C)alkynyl, (1-4C)alkoxy, halo, amino, nitro, cyano, (1-4C)alkylamino, [(1-4C)alkyl]₂amino and —S(O)₂(1-4C)alkyl; and

R₅ and R₆ are each independently hydrogen or (1-4C)alkyl, or R₅ and R₆ are linked such that, when taken in combination with the atoms to which they are attached, they form a fused 6-membered aromatic ring optionally substituted with one or more groups selected from (1-4C)alkyl, (2-4C)alkenyl, (2-4C)alkynyl, (1-4C)alkoxy, aryl, heteroaryl, carbocyclic and heterocyclic, wherein each aryl, heteroaryl, carbocyclic and heterocyclic group is optionally substituted with one or more groups selected from (1-4C)alkyl, (2-4C)alkenyl, (2-4C)alkynyl, (1-4C)alkoxy, halo, amino, nitro, cyano, (1-4C)alkylamino, [(1-4C)alkyl]₂amino and —S(O)₂(1-4C)alkyl.

In another embodiment, R₃ and R₄ are each independently hydrogen or (1-4C)alkyl, or R₃ and R₄ are linked such that, when taken in combination with the atoms to which they are attached, they form a fused 6-membered aromatic ring optionally substituted with one or more groups selected from (1-4C)alkyl, aryl, heteroaryl, carbocyclic and heterocyclic, wherein each aryl, heteroaryl, carbocyclic and heterocyclic group is optionally substituted with one or more groups selected from (1-4C)alkyl, (2-4C)alkenyl, (2-4C)alkynyl, (1-4C)alkoxy, halo, amino and nitro; and

R₅ and R₆ are each independently hydrogen or (1-4C)alkyl, or R₅ and R₆ are linked such that, when taken in combination with the atoms to which they are attached, they form a fused 6-membered aromatic ring optionally substituted with one or more groups selected from (1-4C)alkyl, aryl, heteroaryl, carbocyclic and heterocyclic, wherein each aryl, heteroaryl, carbocyclic and heterocyclic group is optionally substituted with one or more groups selected from (1-4C)alkyl, (2-4C)alkenyl, (2-4C)alkynyl, (1-4C)alkoxy, halo, amino and nitro.

In another embodiment, R₃ and R₄ are each independently hydrogen or (1-4C)alkyl, or R₃ and R₄ are linked such that, when taken in combination with the atoms to which they are attached, they form a fused 6-membered aromatic ring optionally substituted with one or more groups selected from (1-4C)alkyl, aryl and heteroaryl, wherein each aryl and heteroaryl group is optionally substituted with one or more groups selected from (1-4C)alkyl, (2-4C)alkenyl, (2-4C)alkynyl, (1-4C)alkoxy, halo, amino and nitro; and

R₅ and R₆ are each independently hydrogen or (1-4C)alkyl, or R₅ and R₆ are linked such that, when taken in combination with the atoms to which they are attached, they form a fused 6-membered aromatic ring optionally substituted with one or more groups selected from (1-4C)alkyl, aryl and heteroaryl, wherein each aryl and heteroaryl group is optionally substituted with one or more groups selected from (1-4C)alkyl, (2-4C)alkenyl, (2-4C)alkynyl, (1-4C)alkoxy, halo, amino and nitro.

In another embodiment, R₃ and R₄ are each independently hydrogen or (1-4C)alkyl, or R₃ and R₄ are linked such that, when taken in combination with the atoms to which they are attached, they form a fused 6-membered aromatic ring optionally substituted with one or more groups selected from (1-4C)alkyl and phenyl, wherein each phenyl group is optionally substituted with one or more groups selected from (1-4C)alkyl, (2-4C)alkenyl, (2-4C)alkynyl, (1-4C)alkoxy, halo, amino and nitro; and

R₅ and R₆ are each independently hydrogen or (1-4C)alkyl, or R₅ and R₆ are linked such that, when taken in combination with the atoms to which they are attached, they form a fused 6-membered aromatic ring optionally substituted with one or more groups selected from (1-4C)alkyl and phenyl, wherein each phenyl group is optionally substituted with one or more groups selected from (1-4C)alkyl, (2-4C)alkenyl, (2-4C)alkynyl, (1-4C)alkoxy, halo, amino and nitro.

In another embodiment:
i) when R₃ and R₄ are hydrogen or (1-4C)alkyl, and R₅ and R₆ are linked to form a fused 6-membered aromatic ring, said ring is optionally substituted with one or two substituents as defined herein; or
ii) when R₅ and R₆ are hydrogen or (1-4C)alkyl, and R₃ and R₄ are linked to form a fused 6-membered aromatic ring, said ring is optionally substituted with one or two substituents as defined herein.

In another embodiment, R₁ is methyl and R₂ is methyl or ethyl.

In another embodiment, Q is a bridging group comprising 1, 2 or 3 bridging atoms selected from C, B, or Si, or a combination thereof, and is optionally substituted with one or more groups selected from hydroxyl, (1-6C)alkyl, (2-6C)alkenyl, (2-6C)alkynyl, (1-6C)alkoxy and aryl;

In another embodiment, Q is a bridging group comprising 1, 2 or 3 bridging atoms selected from C, Si, or a combination thereof, and is optionally substituted with one or more groups selected from hydroxyl, (1-6C)alkyl, (2-6C)alkenyl, (2-6C)alkynyl, (1-6C)alkoxy and aryl.

In another embodiment, Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. Suitably, Rₐ, R_{b}, R_{c} and R_{d} are each hydrogen, and Rₑ and R_{f} are each independently (1-6C)alkyl, (2-6C)alkenyl or phenyl. More suitably, Rₐ, R_{b}, R_{c} and R_{d} are each hydrogen, and Rₑ and R_{f} are each independently (1-4C)alkyl, (2-4C)alkenyl or phenyl.

In an embodiment, Q is a bridging group having the formula —[Si(Rₑ)(R_{f})]—, wherein Rₑ and R_{f} are each independently selected from methyl, ethyl, propyl, allyl or phenyl. Suitably, Q is a bridging group having the formula —[Si(Rₑ)(R_{f})]—, wherein Rₑ and R_{f} are each independently selected from methyl, ethyl, propyl and allyl. More suitably, Rₑ and R_{f} are each methyl.

In another embodiment, each Y group is independently selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, —C(O)NRₓR_{y} or Si[(1-4C)alkyl]₃, wherein Rₓ and R_{y} are independently (1-4C)alkyl;

In another embodiment, each Y is independently selected from halo or a (1-2C)alkyl or aryloxy group which is optionally substituted with one or more substituents selected from (1-6C)alkyl, halo, phenyl, or Si[(1-4C)alkyl]₃. Suitably, each Y is halo. More suitably, each Y is Cl.

In another embodiment, one Y group is a phenoxy group optionally substituted with 1, 2 or 3 groups independently selected from (1-3C)alkyl, and the other Y group is halo.

In another embodiment, each Y is independently selected from halo or a (1-2C)alkyl group which is optionally substituted with halo, phenyl, or Si[(1-4C)alkyl]₃. Suitably, each Y is halo. More suitably, each Y is Cl.

In another embodiment, X is zirconium or hafnium. Suitably, X is zirconium.

In another embodiment, the compound of formula (I) has any of formulae (II), (III) or (IV) shown below:

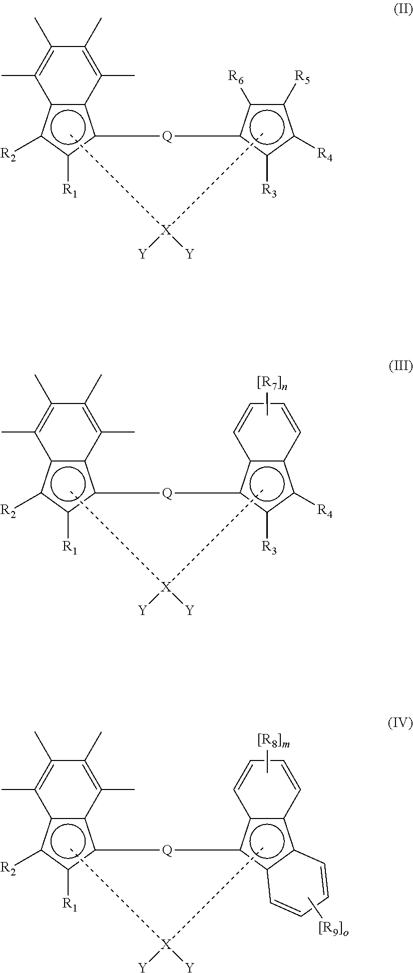

wherein:

R₁, R₂, R₃, R₄, R₅, R₆, Q, X and Y are each independently as defined in any of the paragraphs hereinbefore;

each R₇, R₈ and R₉ is independently selected from any of the ring substituents defined in any of the paragraphs hereinbefore (e.g. any of the substituents present on 6-membered aromatic rings formed when either or both of (i) R₃ and R₄, and (ii) R₅ and R₆, are linked);

n, m and o are independently 0, 1, 2, 3 or 4.

Suitably, n, m and o are independently 0, 1, or 2. More suitably, n, m and o are independently 0, 1 or 2.

In another embodiment, in formulae (II), (III) or (IV), each R₇, R₈ and R₉ is independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro.

Suitably, in formulae (II), (III) or (IV), each R₇, R₈ and R₉ is independently selected from hydrogen, methyl, n-butyl, tert-butyl and unsubstituted phenyl.

In another embodiment, in formula (II), (III) or (IV), R₁ is methyl and R₂ is methyl or ethyl.

In another embodiment, in formula (II), (III) or (IV), Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. Suitably, Q is a bridging group —[Si(Rₑ)(R_{f})]—, wherein Rₑ and R_{f} are independently selected from hydrogen, hydroxyl and (1-6C)alkyl. More suitably, Q is a bridging group —[Si(Rₑ)(R_{f})]—, wherein Rₑ and R_{f} are independently selected from (1-6C)alkyl (e.g. methyl, ethyl, propyl or allyl).

In a particular embodiment, the compound of formula (I) has any of formulae (II), (III) or (IV), wherein

R₁ and R₂ are each independently (1-2C)alkyl;
R₃, R₄, R₅ and R₆ are each independently hydrogen or (1-4C)alkyl;
R₇, R₈ and R₉ are each independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro;
n, m and o are each independently 1 or 2;
Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl;
each Y is independently selected from halo or a (1-2C)alkyl group which is optionally substituted with halo, phenyl, or Si[(1-4C)alkyl]₃; and
X is zirconium or hafnium.

In another particular embodiment, the compound has any of formulae (II), (III) or (IV), wherein

R₁ and R₂ are each independently (1-2C)alkyl;
R₃, R₄, R₅ and R₆ are each independently hydrogen or (1-4C)alkyl;
R₇, R₈ and R₉ are each independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro;
n, m and o are each independently 1 or 2;
Q is a bridging group —[Si(Rₑ)(R_{f})]—, wherein Rₑ and R_{f} are independently selected from hydrogen, hydroxyl and (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

In another particular embodiment, the compound has any of formulae (II), (III) or (IV), wherein

R₁ is methyl and R₂ is methyl or ethyl;
R₃, R₄, R₅ and R₆ are each independently hydrogen or (1-4C)alkyl;
R₇, R₈ and R₉ are each independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro;
n, m and o are each independently 1 or 2;
Q is a bridging group —[Si(Rₑ)(R_{f})]—, wherein Rₑ and R_{f} are independently selected from hydrogen, hydroxyl and (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

In another particular embodiment, the compound has any of formulae (II), (III) or (IV), wherein

R₁ is methyl and R₂ is methyl or ethyl;
R₃, R₄, R₅ and R₆ are each independently hydrogen or (1-4C)alkyl;
R₇, R₈ and R₉ are each independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro;
n, m and o are each independently 1 or 2;
Q is a bridging group —[Si(Rₑ)(R_{f})]—, wherein Rₑ and R_{f} are independently selected from (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

In another embodiment, the compound of formula (I) has any of formulae (V), (VI) or (VII) shown below:

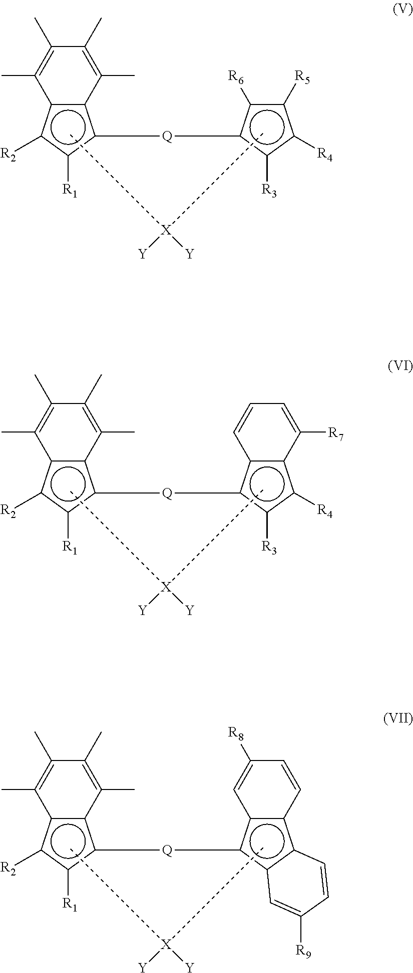

wherein

R₁, R₂, R₃, R₅, R₆, Q, X and Y are each independently as defined in any of the paragraphs hereinbefore;

R₇, R₈ and R₉ are each independently as defined in any of the paragraphs hereinbefore; and
R₄ is as defined in any of the paragraphs hereinbefore. Suitably, R₄ is hydrogen.

Suitably, each R₇, R₈ and R₉ in formulae (V), (VI) or (VII) is independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro.

Suitably, each R₇, R₈ and R₉ in formulae (V), (VI) or (VII) is independently selected from hydrogen, methyl, n-butyl, tert-butyl and unsubstituted phenyl.

In another embodiment, in formulae (V), (VI) or (VII), Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl. Suitably, Q is a bridging group —[Si(Rₑ)(R_{f})]—, wherein Rₑ and R_{f} are independently selected from hydrogen, hydroxyl and (1-6C)alkyl. More suitably, Q is a bridging group —[Si(Rₑ)(R_{f})]—, wherein Rₑ and R_{f} are independently selected from (1-6C)alkyl (e.g. methyl, ethyl, propyl or allyl).

In another embodiment, in formula (V), (VI) or (VII), R₁ is methyl and R₂ is methyl or ethyl.

In a particular embodiment, the compound of formula (I) has any of formulae (V), (VI) or (VII), wherein

R₁ and R₂ are each independently (1-2C)alkyl;
R₃, R₄, R₅ and R₆ are each independently hydrogen or (1-4C)alkyl;
R₇, R₈ and R₉ are each independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro;
Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl;
each Y is independently selected from halo or a (1-2C)alkyl group which is optionally substituted with halo, phenyl, or Si[(1-4C)alkyl]₃; and
X is zirconium or hafnium.

In another particular embodiment, the compound of formula (I) has any of formulae (V), (VI) or (VII), wherein

R₁ and R₂ are each independently (1-2C)alkyl;
R₃, R₄, R₅ and R₆ are each independently hydrogen or (1-4C)alkyl;
R₇, R₈ and R₉ are each independently selected from hydrogen, methyl, n-butyl, tert-butyl and unsubstituted phenyl;
Q is a bridging group selected from —[C(Rₐ)(R_{b})—C(R_{c})(R_{d})]— and —[Si(Rₑ)(R_{f})]—, wherein Rₐ, R_{b}, R_{c} and R_{d} are each hydrogen, and Rₑ and R_{f} are each independently (1-6C)alkyl, (2-6C)alkenyl or phenyl;
each Y is independently selected from halo or a (1-2C)alkyl group which is optionally substituted with halo, phenyl, or Si[(1-4C)alkyl]₃; and
X is zirconium or hafnium.

In another particular embodiment, the compound has any of formulae (V), (VI) or (VII), wherein

R₁ and R₂ are each independently (1-2C)alkyl;
R₃, R₄, R₅ and R₆ are each independently hydrogen or (1-4C)alkyl;
R₇, R₈ and R₉ are each independently selected from hydrogen, methyl, n-butyl, tert-butyl and unsubstituted phenyl;
Q is a bridging group —[Si(Rₑ)(R_{f})]—, wherein Rₑ and R_{f} are independently selected from hydrogen, hydroxyl and (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

In another particular embodiment, the compound has any of formulae (V), (VI) or (VII), wherein

R₁ is methyl and R₂ is methyl or ethyl;
R₃, R₄, R₅ and R₆ are each independently hydrogen or (1-4C)alkyl;
R₇, R₈ and R₉ are each independently selected from hydrogen, methyl, n-butyl, tert-butyl and unsubstituted phenyl;
Q is a bridging group —[Si(Rₑ)(R_{f})]—, wherein Rₑ and R_{f} are independently selected from hydrogen, hydroxyl and (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

In another particular embodiment, the compound has any of formulae (V), (VI) or (VII), wherein

R₁ is methyl and R₂ is methyl or ethyl;
R₃, R₄, R₅ and R₆ are each independently hydrogen or (1-4C)alkyl;
R₇, R₈ and R₉ are each independently selected from hydrogen, (1-4C)alkyl and phenyl, said phenyl group being optionally substituted with one or more groups selected from (1-4C)alkyl, (2-4C)alkenyl, (2-4C)alkynyl, (1-4C)alkoxy, halo, amino and nitro;
n, m and o are each independently 1 or 2;
Q is a bridging group —[Si(Rₑ)(R_{f})]—, wherein Rₑ and R_{f} are independently selected from (1-6C)alkyl;
each Y is independently selected from halo, (1-2C)alkyl, or an aryloxy group which is optionally substituted with one or more substituents selected from (1-4C)alkyl, halo, phenyl, or Si[(1-4C)alkyl]₃; and
X is zirconium or hafnium.

In another embodiment, the compound of formula I has any of the following structures:

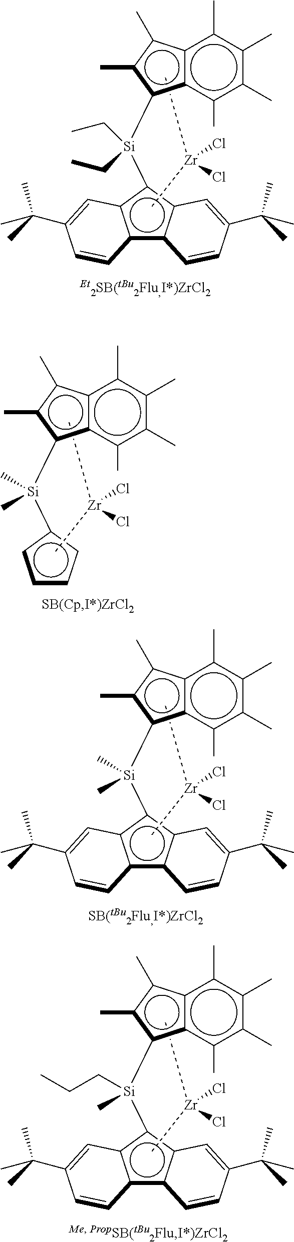

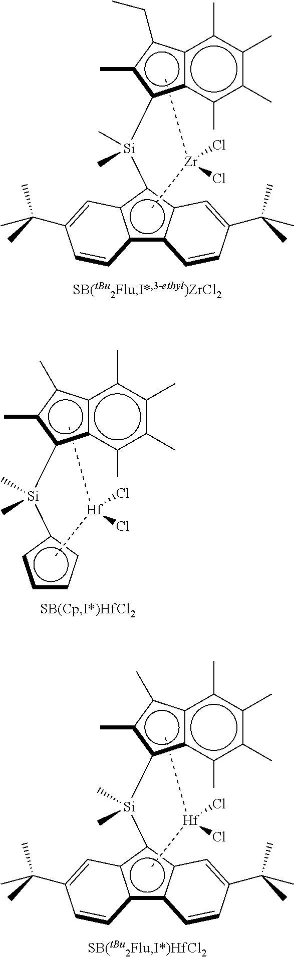

In another embodiment, the compound of formula (I) has the following structure:

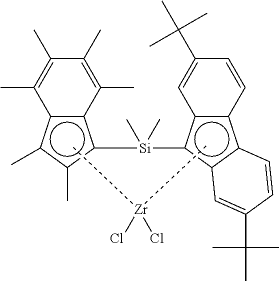

In another aspect, the present invention provides a compound of formula (I) as defined hereinbefore.

### Synthesis

The compounds forming part of the present invention may be synthesised by any suitable process known in the art. Particular examples of processes for the preparing compounds forming part of the present invention are set out in the accompanying examples.

Suitably, a compound of the present invention is prepared by:
(i) reacting a compound of formula A:

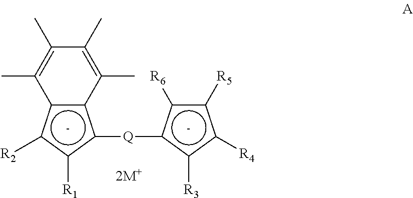

(wherein R₁, R₂, R₃, R₄, R₅, R₆ and Q are each as defined hereinbefore and M is Li, Na or K)
with a compound of the formula B:

X(Y′)₄ B
(wherein X is as defined hereinbefore and Y′ is halo (particularly chloro or bromo)) in the presence of a suitable solvent to form a compound of formula (Ia):

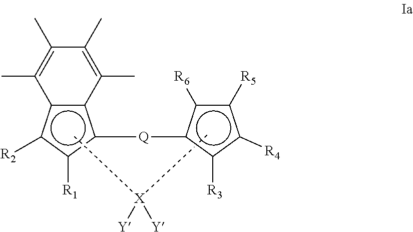

and optionally thereafter:
(ii) reacting the compound of formula Ia above with MY″ (wherein M is as defined above and Y″ is a group Y as defined herein other than halo), in the presence of a suitable solvent to form the compound of the formula (Ib) shown below

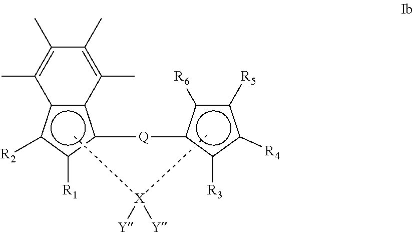

Suitably, M is Li in step (i) of the process defined above.

Suitably, the compound of formula B is provided as a solvate. In particular, the compound of formula B may be provided as X(Y)₄.THFₚ, where p is an integer (e.g. 2).

Any suitable solvent may be used for step (i) of the process defined above. A particularly suitable solvent is toluene or THF.

If a compound of formula (I) in which Y is other than halo is required, then the compound of formula (Ia) above may be further reacted in the manner defined in step (ii) to provide a compound of formula (Ib).

Any suitable solvent may be used for step (ii) of the process defined above. A suitable solvent may be, for example, diethyl ether, toluene, THF, dicloromethane, chloroform, hexane DMF, benzene etc.

Compounds of formula A, in which Q is —[Si(Rₑ)(R_{f})]—, may generally be prepared by:
(i) Reacting a compound of formula D

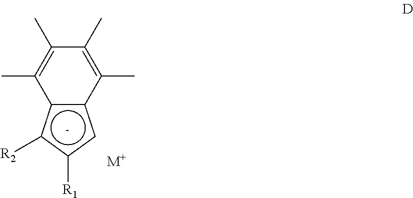

(wherein M is lithium, sodium, or potassium; and R₁ and R₂ are as defined hereinbefore) with one equivalent of a compound having formula E shown below:

Si(Rₑ)(R_{f})(Cl)₂ E
(wherein Rₑ and R_{f} are as defined hereinbefore)
to form the compound of the formula F shown below:

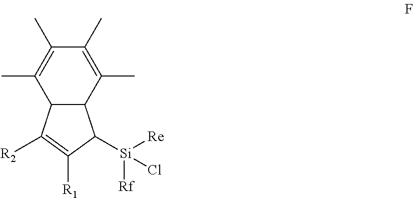

(ii) Reacting the compound of formula F with a compound of formula G shown below:

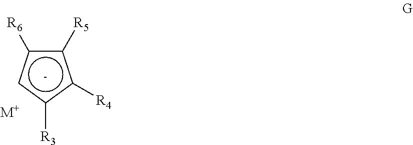

(wherein R₃, R₄, R₅ and R₆ are as defined hereinbefore, and M is lithium, sodium or potassium).

Compounds of formulae D and G can be readily synthesized by techniques well known in the art.

Any suitable solvent may be used for step (i) of the above process. A particularly suitable solvent is THF.

Similarly, any suitable solvent may be used for step (ii) of the above process. A suitable solvent may be, for example, toluene, THF, DMF etc.

A person of skill in the art will be able to select suitable reaction conditions (e.g. temperature, pressures, reaction times, agitation etc.) for such a synthesis.

Compounds of formula A, in which Q is —CH₂—CH₂—, may generally be prepared by:
(i) Reacting a compound of formula D

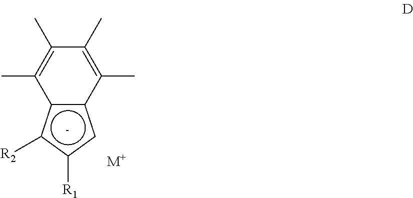

(wherein M is lithium, sodium, or potassium; and R₁ and R₂ are as defined hereinbefore) with an excess of BrCH₂CH₂Br to form a compound of the formula H shown below:

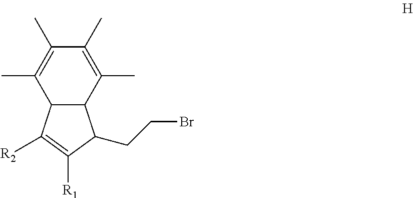

(wherein R₁ and R₂ are as defined hereinbefore); and
(ii) Reacting the compound of formula H with a compound of formula G shown below:

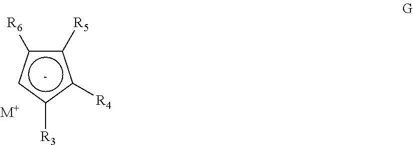

(wherein R₃, R₄, R₅ and R₆ are as defined hereinbefore, and M is lithium, sodium or potassium)

Compounds of formulae D and G can be readily synthesized by techniques well known in the art.

Any suitable solvent may be used for step (i) of the above process. A particularly suitable solvent is THF.

Similarly, any suitable solvent may be used for step (ii) of the above process. A suitable solvent may be, for example, toluene, THF, DMF etc.

A person of skill in the art will be able to select suitable reaction conditions (e.g. temperature, pressures, reaction times, agitation etc.) for such a synthesis.

### Applications

As previously indicated, the compositions of the present invention are extremely effective as catalysts in polyethylene homopolymerization and copolymerisation reactions.

As discussed hereinbefore, the compositions of the invention exhibit superior catalytic performance when compared with current metallocene compounds used in the polymerisation of α-olefins. In particular, when compared with analogous silica-supported methyl aluminoxane (SSMAO) and layered double hydroxide-supported methyl aluminoxane (LDHMAO) catalyst compositions, the solid MAO compositions of the invention exhibit significantly increased catalytic activity in the homopolymerisation and copolymerisation of α-olefins. Moreover, polymers produced by α-olefin polymerization in the presence of compositions of the invention are typically of a higher molecular weight than polymers prepared using other catalysts, without an attendant increase in polydispersity. Such materials are highly valued by industry. Furthermore, polyethylene copolymers produced by α-olefin polymerization in the presence of compositions of the invention demonstrate good co-monomer incorporation in polyethylene, with good inter-molecular uniformity.

Thus, as discussed hereinbefore, the present invention also provides the use of a composition defined herein as a polymerization catalyst, in particular in the preparation of polyethylene.

In one embodiment, the polyethylene is a homopolymer made from polymerized ethene monomers.

In another embodiment, the polyethylene is a copolymer made from polymerized ethene monomers comprising 1-10 wt % of (4-8C) α-olefin (by total weight of the monomers). Suitably, the (4-8C) α-olefin is 1-butene, 1-hexene, 1-octene, or a mixture thereof.

In another embodiment, the polyethylene is a polyethylene wax. Polyethylene wax will be understood by one of skill in the art as being low molecular weight polyethylene, typically having an average molecular weight of 1000-15,000 Da. Suitably, the polyethylene wax has an average molecular weight of 1000-6000 Da.

As discussed hereinbefore, the present invention also provides a process for forming a polyolefin (e.g. a polyethylene) which comprises reacting olefin monomers in the presence of a composition defined herein.

In another embodiment, the olefin monomers are ethene monomers.

In another embodiment, the olefin monomers are ethene monomers comprising 1-10 wt % of (4-8C) α-olefin (by total weight of the monomers). Suitably, the (4-8C) α-olefin is 1-butene, 1-hexene, 1-octene, or a mixture thereof.

In another embodiment, the polyolefin is a polyethylene wax, which is formed by reacting ethene monomers and H₂ in the presence of a composition as defined herein.

Optionally, quantities of 1-butene may be included together with the ethene monomers and H₂.

A person skilled in the art of olefin polymerization will be able to select suitable reaction conditions (e.g. temperature, pressures, reaction times etc.) for such a polymerization reaction. A person skilled in the art will also be able to manipulate the process parameters in order to produce a polyolefin having particular properties.

In a particular embodiment, the polyolefin is polyethylene.

### EXAMPLES

Examples of the invention will now be described, for the purpose of reference and illustration only, with reference to the accompanying figures, in which:

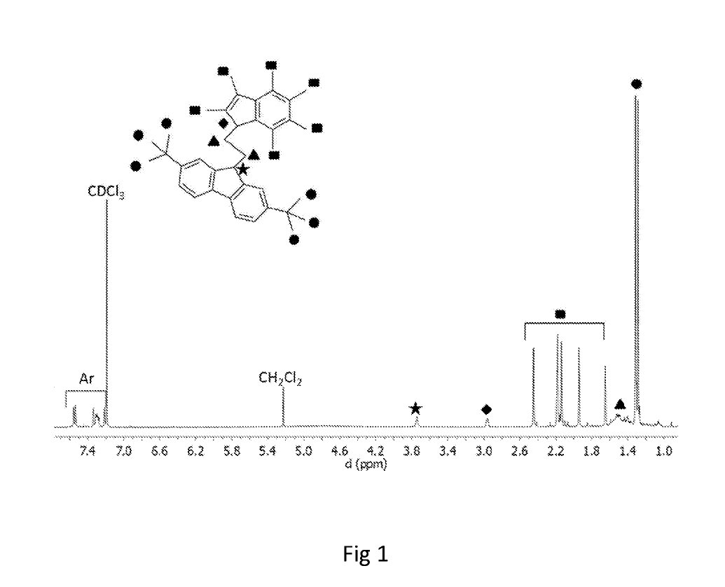

FIG. 1 shows the ¹H NMR spectroscopy (chloroform-d₁, 298 K, 400 MHz) of pro-ligand [EB(^{tBu}^{₂}Flu,I*)H₂].

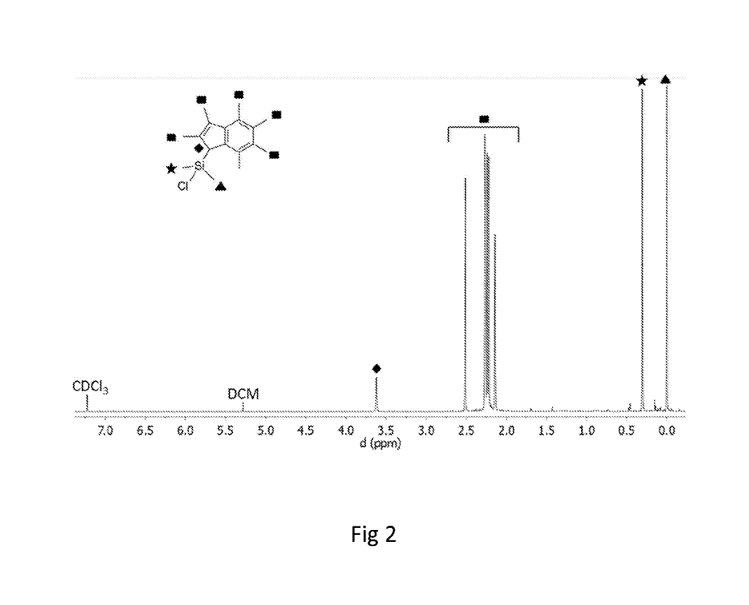

FIG. 2 shows the ¹H NMR spectroscopy (chloroform-d₁, 298 K, 400 MHz) of pro-ligand [^{Me}^{₂}Si(Ind*)Cl].

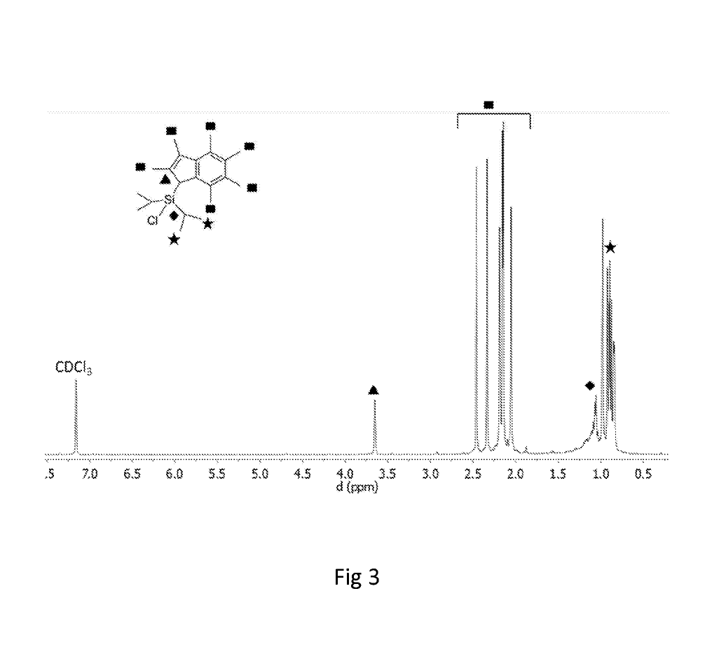

FIG. 3 shows the ¹H NMR spectroscopy (chloroform-d₁, 298 K, 400 MHz) of pro-ligand [^{iPr}^{₂}Si(Ind*)Cl].

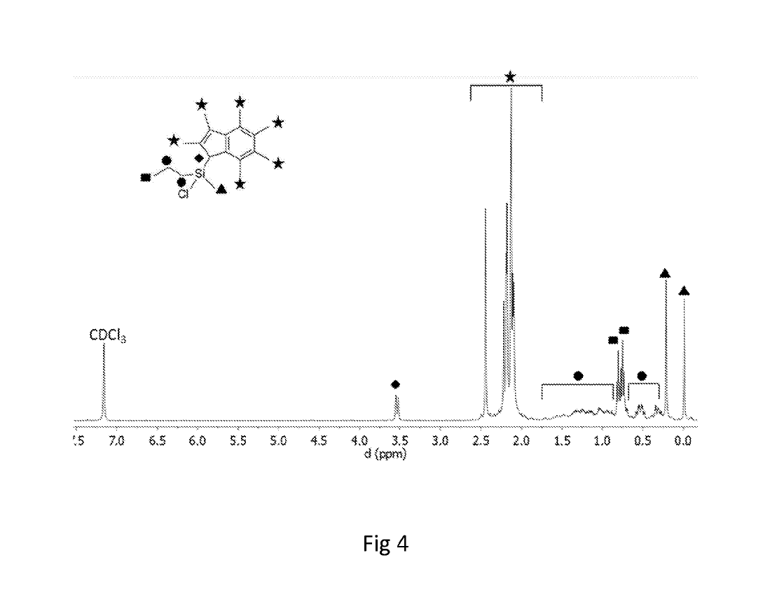

FIG. 4 shows the ¹H NMR spectroscopy (chloroform-d₁, 298 K, 400 MHz) of pro-ligand [^{Me,Propyl}Si(Ind*)Cl].

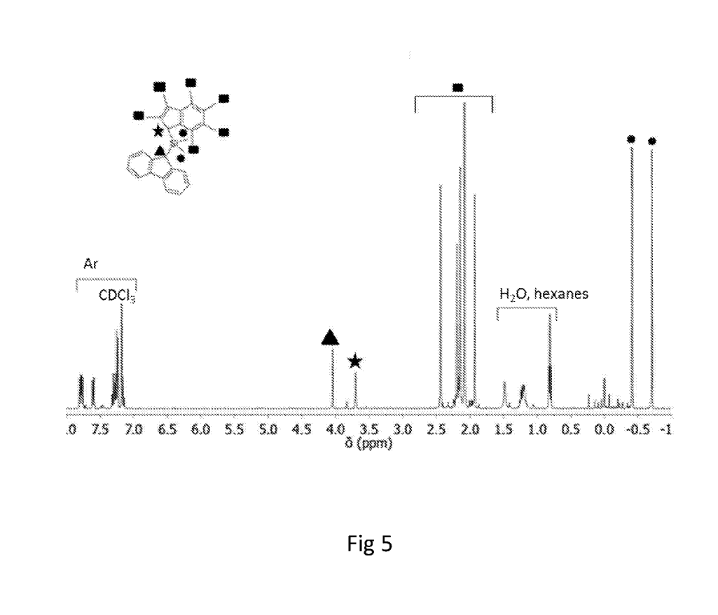

FIG. 5 shows the ¹H NMR spectroscopy (chloroform-d₁, 298 K, 400 MHz) of pro-ligand [SB(Flu,I*)H₂].

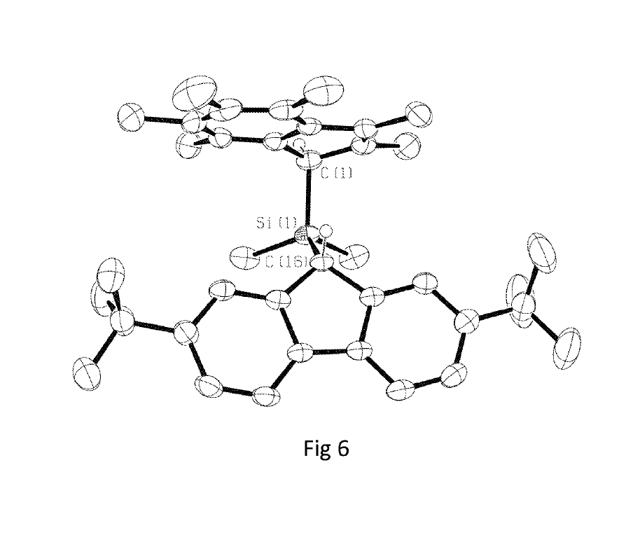

FIG. 6 shows the Molecular structure of [SB(^{tBu}^{₂}Flu,I*)H₂], 50% ellipsoids, hydrogen atoms omitted for clarity; black: carbon, pink: silicon. Selected bond lengths (A) and angle (1, Si-CH₃ 1.863 (3), 1.868(3), Si-CH_{Ind}: 1.939(2), Si-CH_{Ind}: 1.926(2) and HC_{Flu}-Si-CH_{Ind}: 111.34(12).

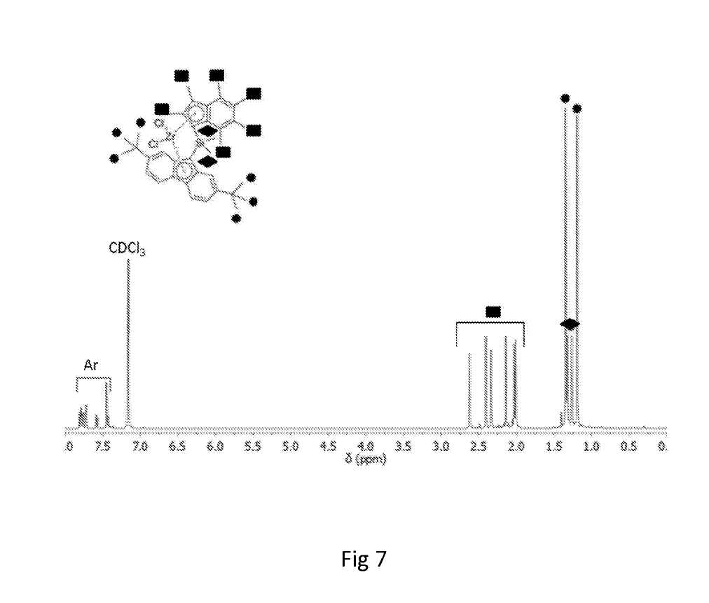

FIG. 7 shows the ¹H NMR spectroscopy (chloroform-d₁, 298 K, 400 MHz) of [SB(^{tBu}^{₂}Flu,I*)ZrCl₂].

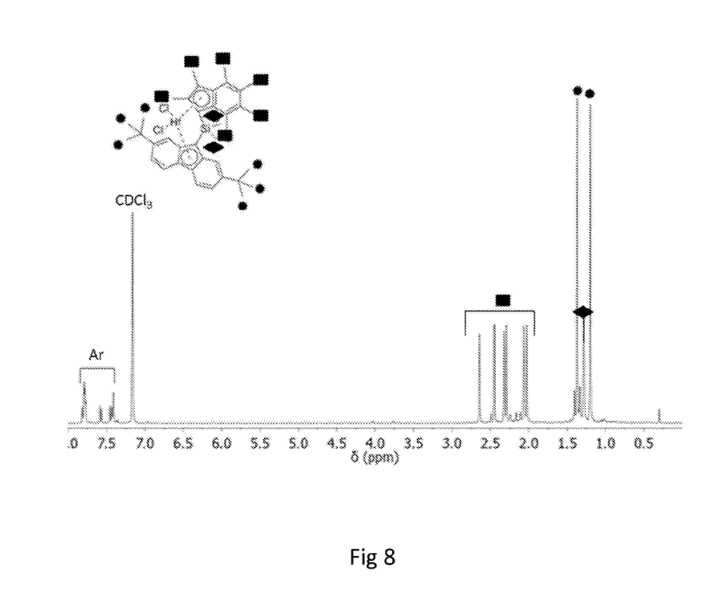

FIG. 8 shows the ¹H NMR spectroscopy (chloroform-d₁, 298 K, 400 MHz) of [SB(^{tBu}^{₂}Flu,I*)HfCl₂].

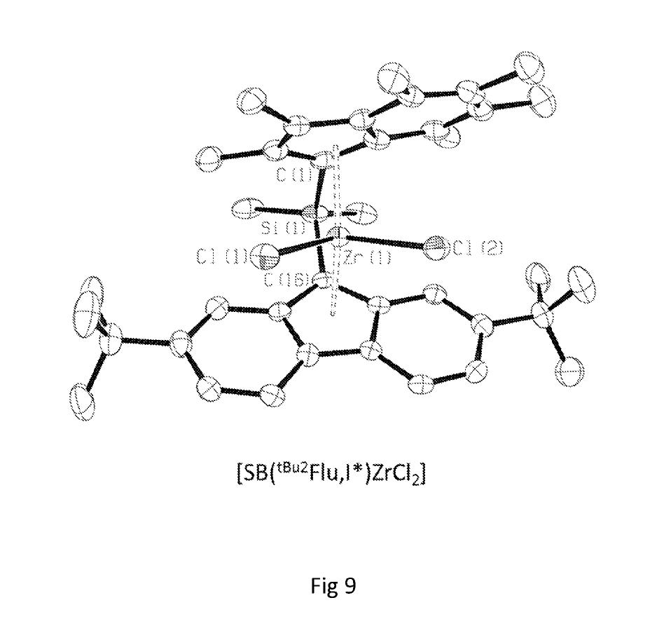

FIG. 9 shows the molecular structure of [SB(^{tBu}^{₂}Flu,I*)ZrCl₂].

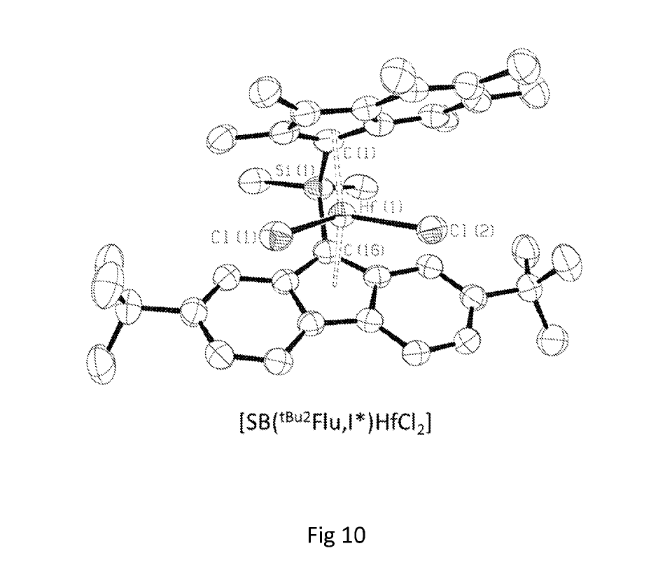

FIG. 10 shows the molecular structure of [SB(^{tBu}^{₂}Flu,I*)HfCl₂].

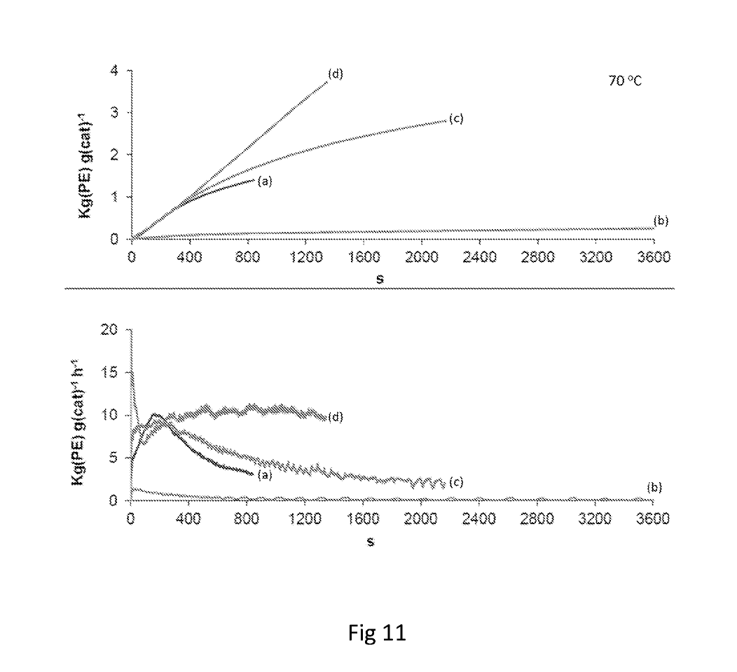

FIG. 11 shows polymerisation productivity (Kg(PE)g(Cat)⁻¹h⁻¹) vs time (sec) for the homopolymerisation of ethylene using Solid MAO supported catalytic systems: (a) rac-[(EBI*)ZrCl₂], (b) meso-[(EBI*)ZrCl₂], (c) rac-[(SBI*)ZrCl₂], and (d) [SB(^{tBu}^{₂}Flu,I*)ZrCl₂]. Polymerisation conditions: 5 mL heptane, P_{ethylene}=120 psi, T=70° C. and n_{(TEA)}=10 μmol.

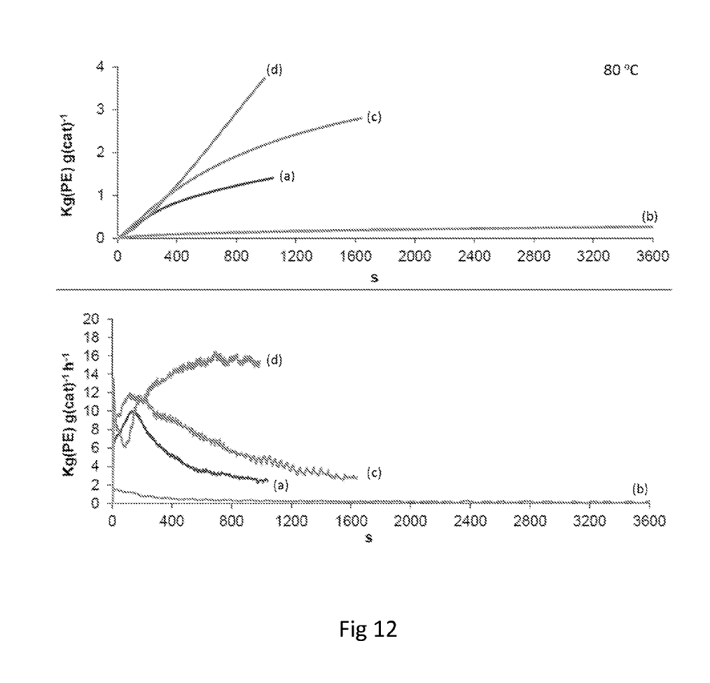

FIG. 12 shows polymerisation productivity (Kg(PE)g(Cat)⁻¹h⁻¹) vs time (sec) for the homopolymerisation of ethylene using Solid MAO supported catalytic systems: (a) rac-[(EBI*)ZrCl₂], (b) meso-[(EBI*)ZrCl₂], (c) rac-[(SBI*)ZrCl₂], and (d) [SB(^{tBu}^{₂}Flu,I*)ZrCl₂]. Polymerisation conditions: 5 mL heptane, P_{ethylene}=120 psi, T=80° C. and n_{(TEA)}=10 μmol.

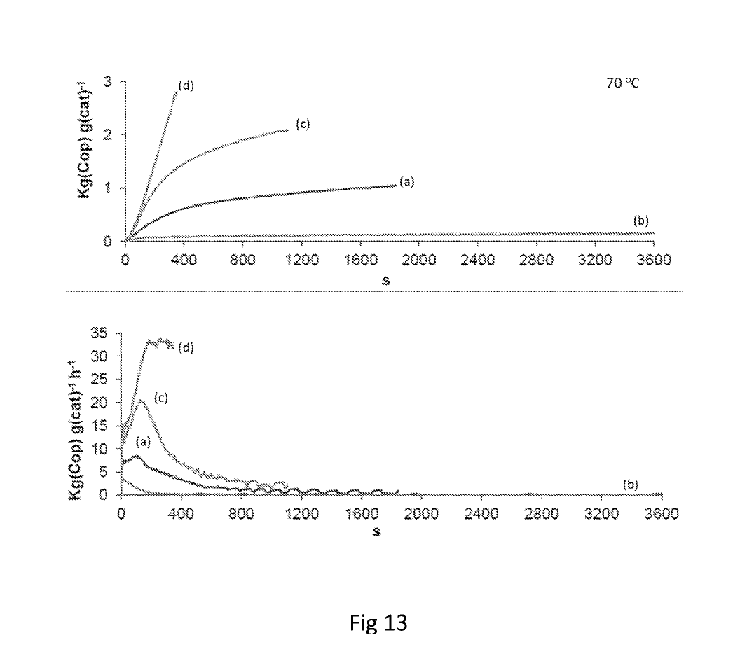

FIG. 13 shows activity vs time for the copolymerisation of ethylene and 1-hexene using Solid MAO supported catalytic systems: (a) rac-[(EBI*)ZrCl₂], (b) meso-[(EBI*)ZrCl₂] (c) rac-[(SBI*)ZrCl₂], (d) [SB(^{tBu}^{₂}Flu,I*)ZrCl₂]. Polymerisation conditions: 5 mL heptane, P_{ethylene}=120 psi, T=70° C., [Hexene]feed=5 vol %, and n_{(TEA)}=15 μmol.

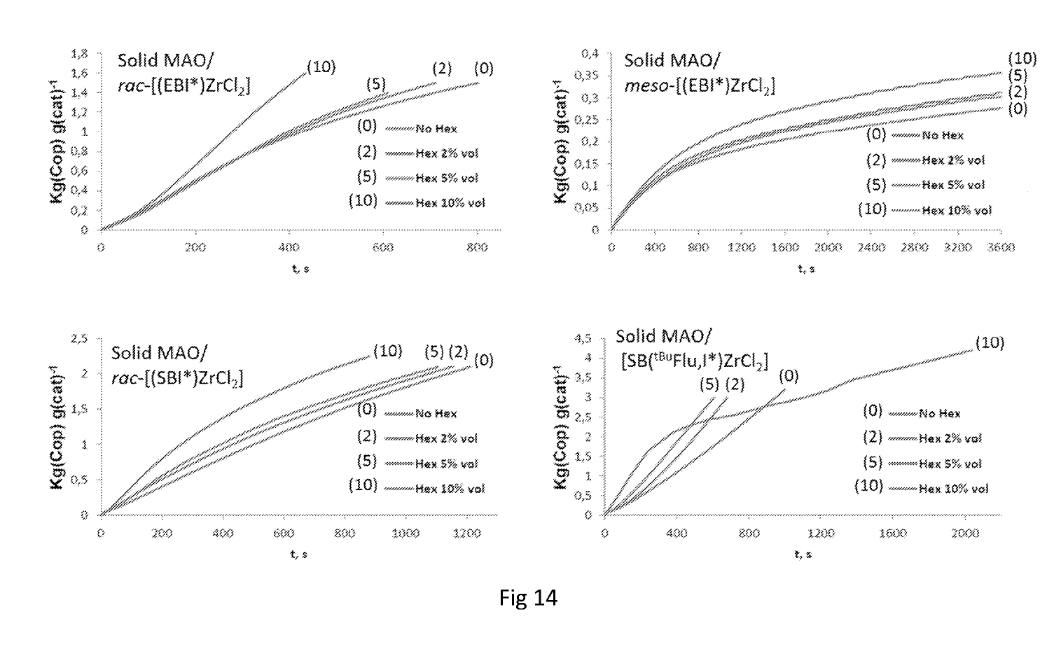

FIG. 14 shows activity vs time for the copolymerisation of ethylene and 1-hexene using Solid MAO supported catalytic systems with variation of the 1-hexene feed. Polymerisation conditions: 5 mL heptane, P_{ethylene}=120 psi, T=70° C., and n_{(TEA)}=15 μmol.

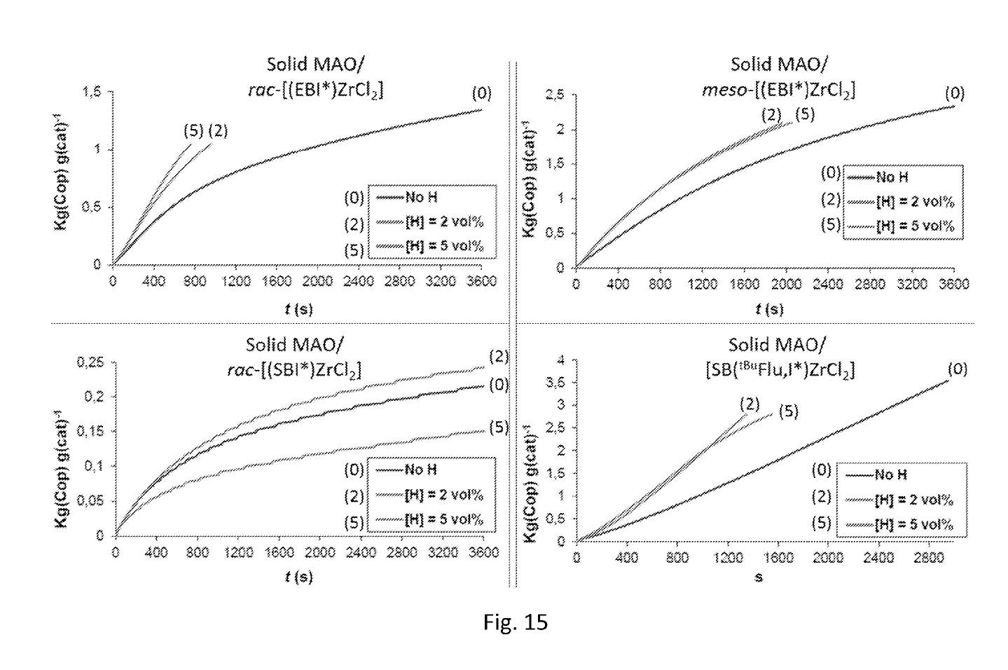

FIG. 15 shows activity vs time for the copolymerisation of ethylene and 1-hexene using Solid MAO supported catalytic systems with variation of the 1-hexene feed. Polymerisation conditions: 5 mL heptane, P_{ethylene}=80 psi, T=70° C., and n_{(TEA)}=15 μmol.

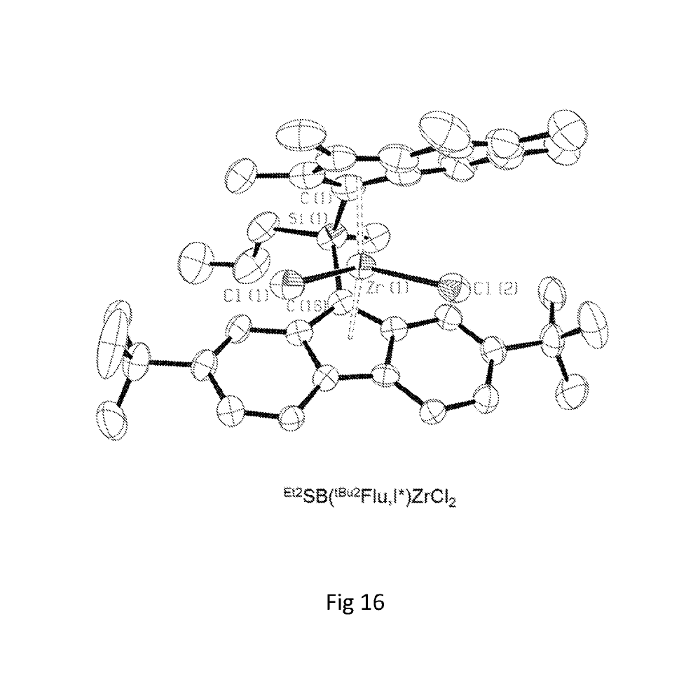

FIG. 16 shows the molecular structure of ^{Et2}SB(^{tBu}^{₂}Flu,I*)ZrCl₂.

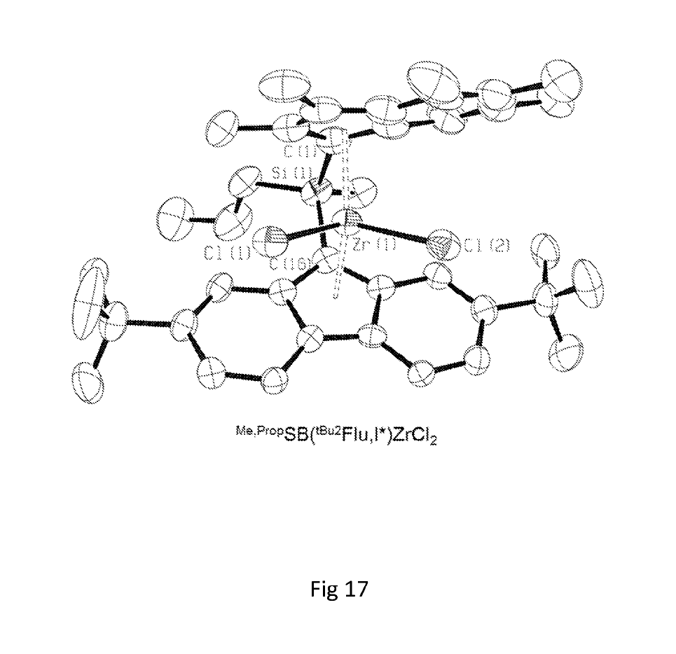

FIG. 17 shows the molecular structure of ^{Me,Prop}SB(^{tBu}^{₂}Flu,I*)ZrCl₂.

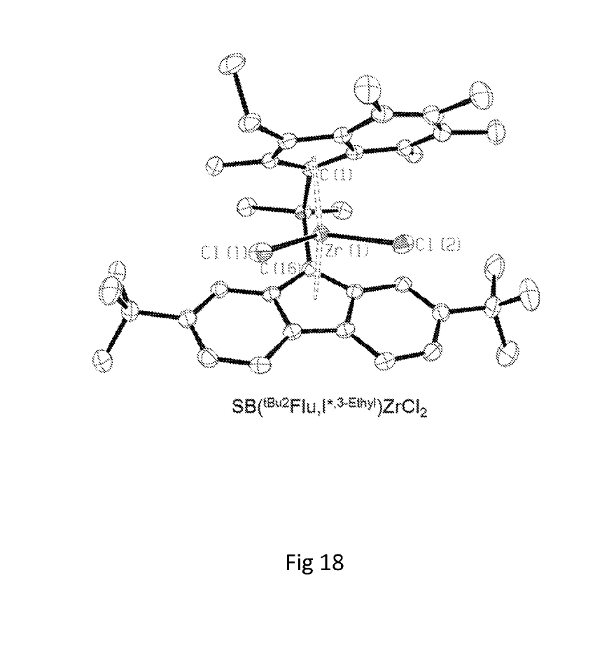

FIG. 18 shows the molecular structure of SB(^{tBu}^{₂}Flu,I*^{3-ethyl})ZrCl₂.

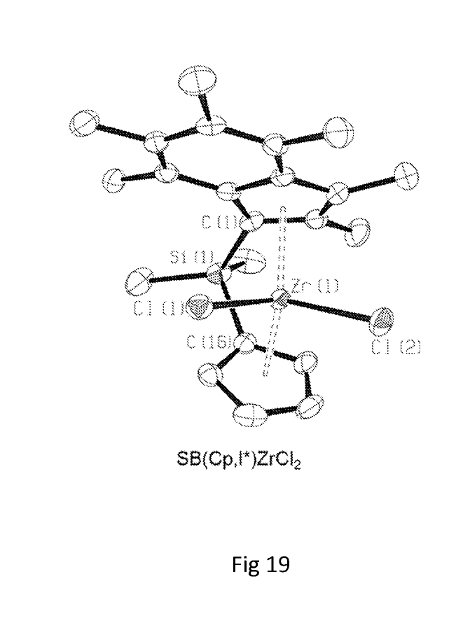

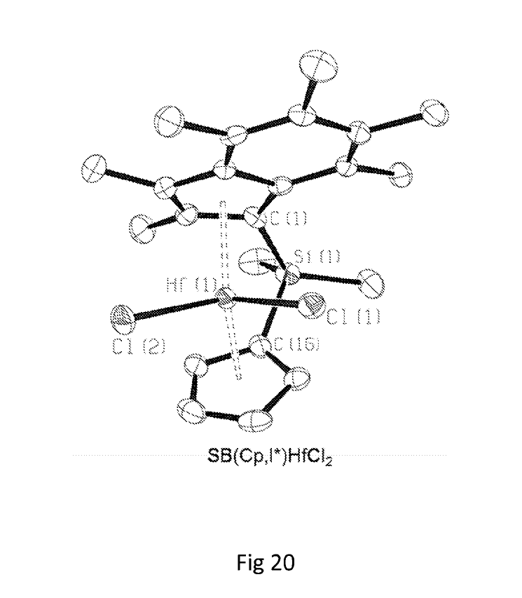

FIG. 19 shows the molecular structure of SB(Cp,I*)ZrCl₂. FIG. 20 shows

FIG. 20 shows the molecular structure of SB(Cp,I*)HfCl₂.

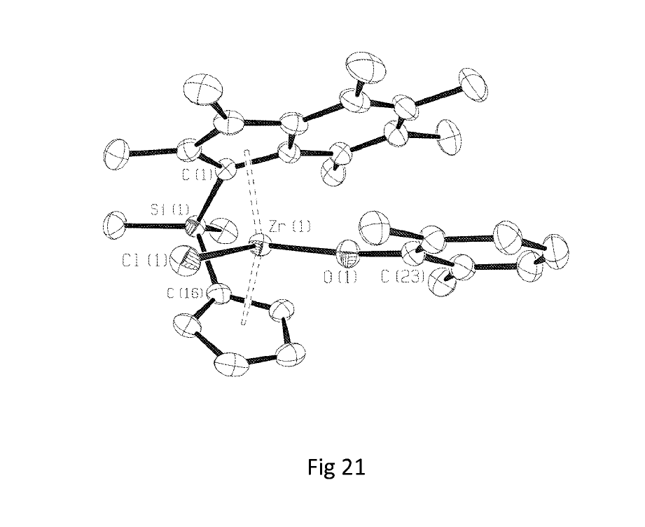

FIG. 21 shows the molecular structure of SB(Cp,I*)ZrCl(O-2,6-Me₂-C₆H₃).

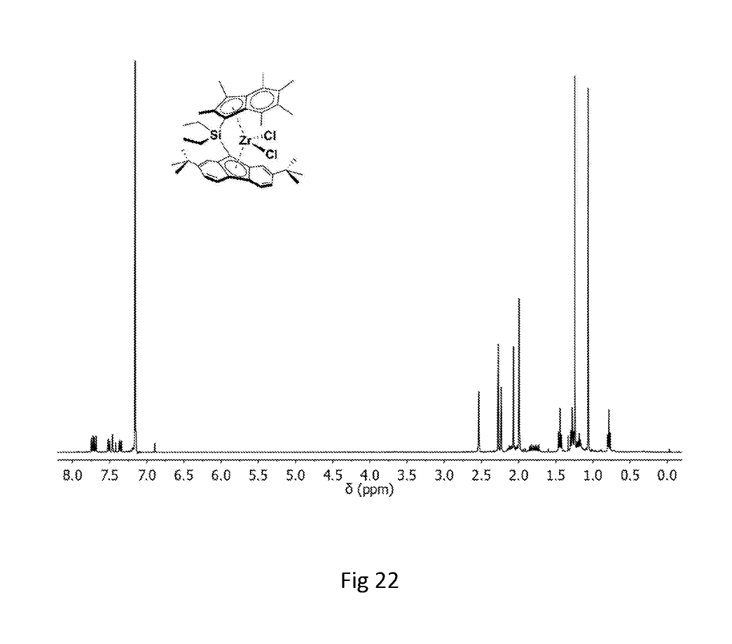

FIG. 22 shows the ¹H NMR spectroscopy (chloroform-d₁, 298 K, 400 MHz) of ^{Et2}SB(^{tBu}^{₂}Flu,I*)ZrC1₂.

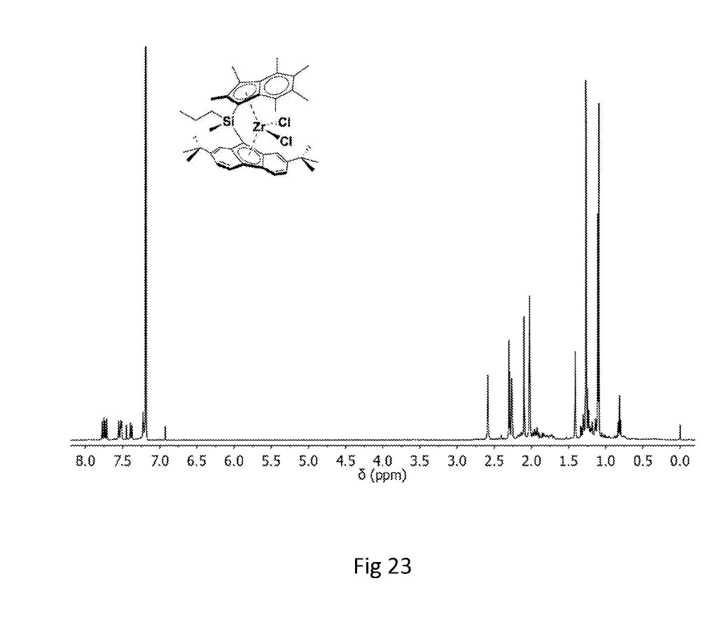

FIG. 23 shows the ¹H NMR spectroscopy (chloroform-d₁, 298 K, 400 MHz) of ^{Me,Prop}SB(^{tBu}^{₂}Flu,I*)ZrCl₂.

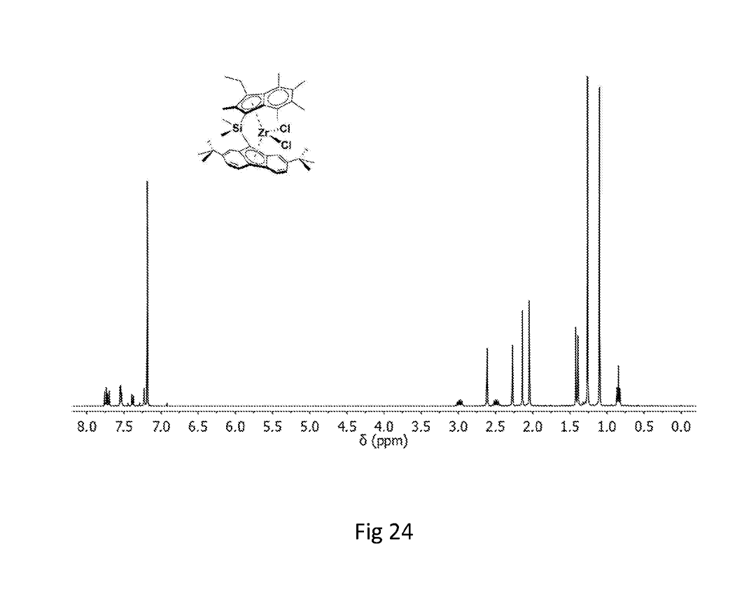

FIG. 24 shows the ¹H NMR spectroscopy (chloroform-d₁, 298 K, 400 MHz) of SB(^{tBu}^{₂}Flu,I*^{,3-ethyl})ZrCl₂.

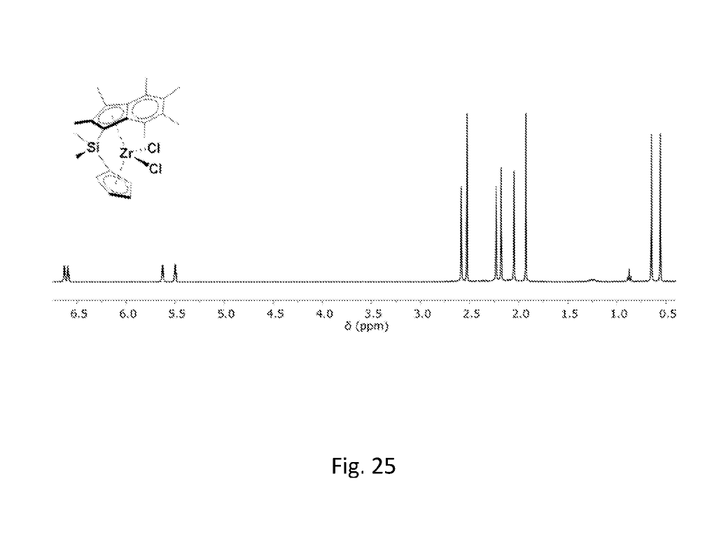

FIG. 25 shows the ¹H NMR spectroscopy (chloroform-d₁, 298 K, 400 MHz) of SB(Cp,I*)ZrCl₂.

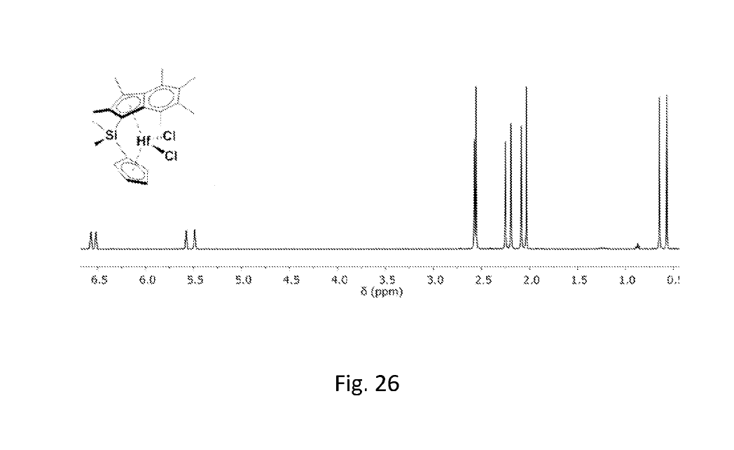

FIG. 26 shows the ¹H NMR spectroscopy (chloroform-d₁, 298 K, 400 MHz) of SB(Cp,I*)HfCl₂.

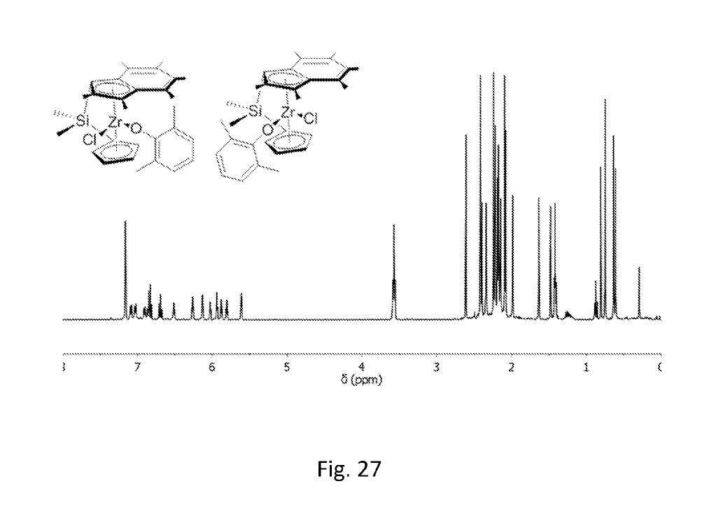

FIG. 27 shows the ¹H NMR spectroscopy (chloroform-d₁, 298 K, 400 MHz) of SB(Cp,I*)ZrCl(O-2,6-Me₂-C₆H₃).

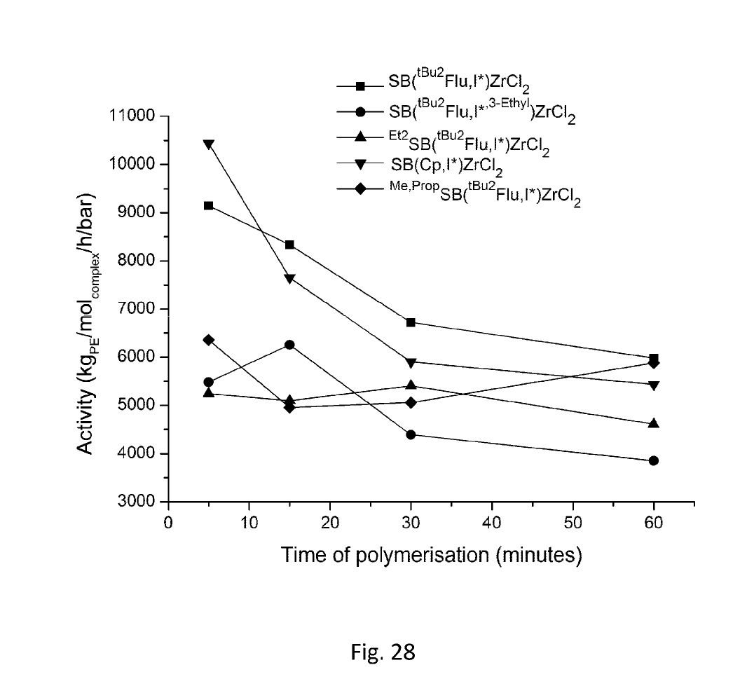

FIG. 28 shows activity vs time of polymerisation of ethylene using solid MAO supported/SB(^{tBu}^{₂}Flu,I*)ZrCl₂ (square), solid MAO supported/SB(^{tBu}^{₂}Flu,I*^{,3-Ethyl})ZrCl₂ (circle), solid MAO supported/^{Et2}SB(^{tBu}^{₂}Flu,I*)ZrCl₂ (triangle), solid MAO supported/SB(Cp,I*)ZrCl₂ (inverted triangle) and solid MAO supported/^{Me,ProP}SB(^{tBu}^{₂}Flu,I*)ZrCl₂ (diamond). Polymerisation conditions: 10 mg of catalyst, 50 mL hexanes, 2 bar, 70° C., and [TIBA]₀/[Zr]₀=1000.

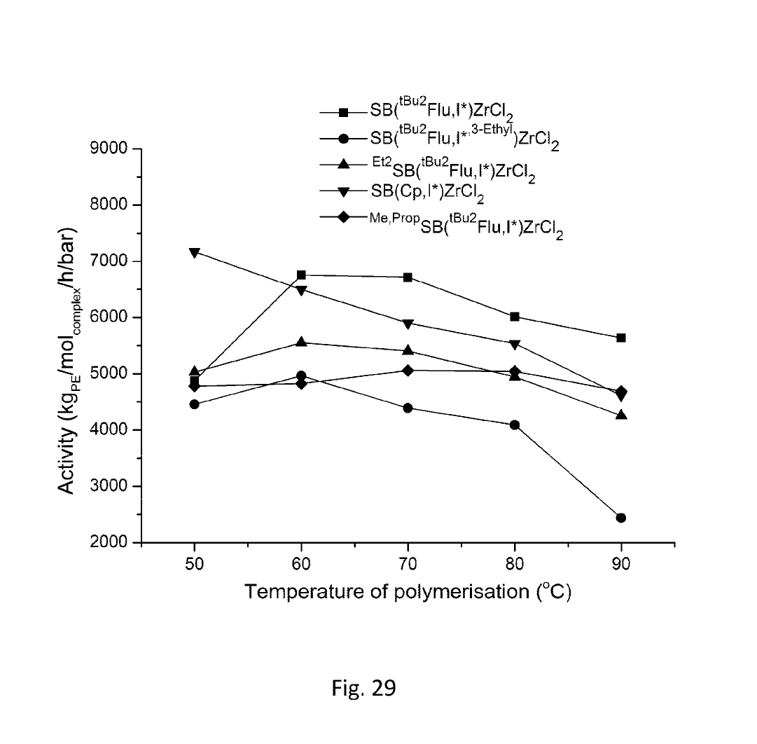

FIG. 29 shows activity vs temperature of polymerisation of ethylene using solid MAO supported/SB(^{tBu}^{₂}Flu,I*)ZrCl₂ (square), solid MAO supported/SB(^{tBu}^{₂}Flu,I*^{,3-Ethyl})ZrCl₂ (circle), solid MAO supported/^{Et2}SB(^{tBu}^{₂}Flu,I*)ZrCl₂ (triangle), solid MAO supported/SB(Cp,I*)ZrCl₂ (inverted triangle) and solid MAO supported/^{Me,Prop}SB(^{tBu}^{₂}Flu,I*)ZrCl₂ (diamond). Polymerisation conditions: 10 mg of catalyst, 50 mL hexanes, 2 bar, 0.5 h, and [TIBA]₀/[Zr]₀=1000.

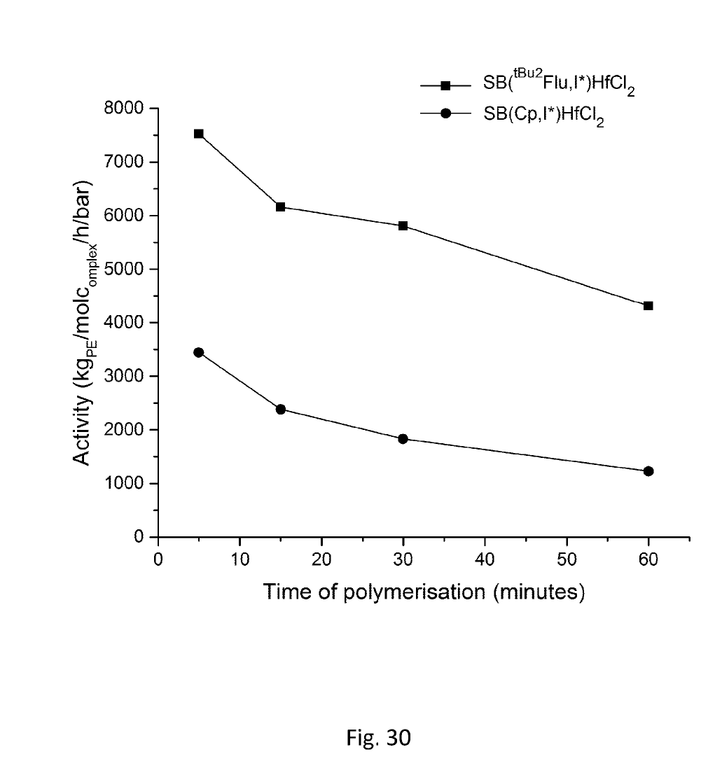

FIG. 30 shows activity vs time of polymerisation of ethylene using solid MAO supported/SB(^{tBu}^{₂}Flu,I*)ZrCl₂ (square) and solid MAO supported/SB(Cp,I*)ZrCl₂ (circle). Polymerisation conditions: 10 mg of catalyst, 50 mL hexanes, 2 bar, 70° C., and [TIBA]₀/[Zr]₀=1000.

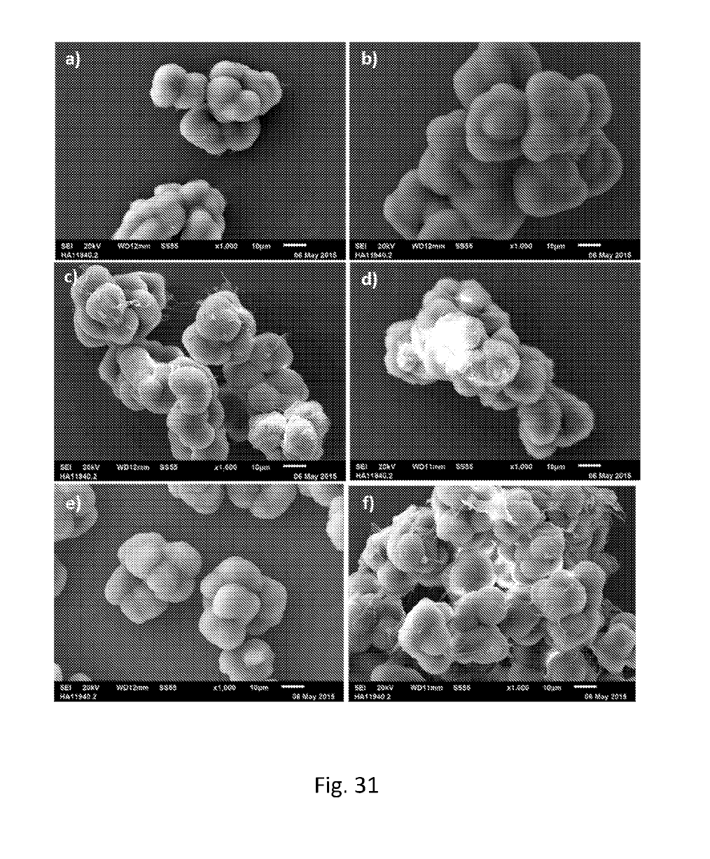

FIG. 31 shows SEM pictures of a) solid MAO supported/^{Et2}SB(^{tBu}^{₂}Flu,I*)ZrCl₂, b) solid MAO supported/^{Me,Prop}SB(^{tBu}^{₂}Flu,I*)ZrCl₂, c) solid MAO supported SB(^{tBu}^{₂}Flu,I*)ZrCl₂, d) solid MAO supported SB(^{tBu}^{₂}Flu,I*)HfCl₂, e) solid MAO supported/SB(Cp,I*)ZrCl₂ and f) solid MAO supported/SB(^{tBu}^{₂}Flu,I*^{,3-Ethyl})ZrCl₂. Polymerisation conditions: 10 mg of catalyst, 50 mL hexanes, 2 bar, 70° C., 0.5 h and [TIBA]₀/[Zr]₀=1000.

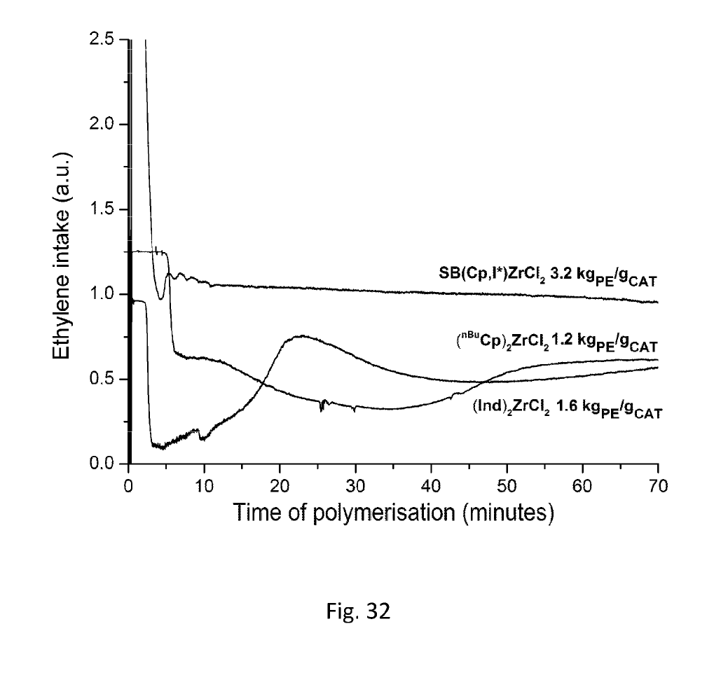

FIG. 32 shows activity vs time of polymerisation of ethylene using 3% H₂ used as co-feed using solid MAO supported/SB(Cp,I*)ZrCl₂, solid MAO supported/(^{nBu}Cp)₂ZrCl₂ and solid MAO supported/(Ind)₂ZrCl₂. Polymerisation conditions: 25 mg of catalyst, 1000 mL hexanes, 8 bar, 80° C., and [TEA]₀/[Zr]₀=300.

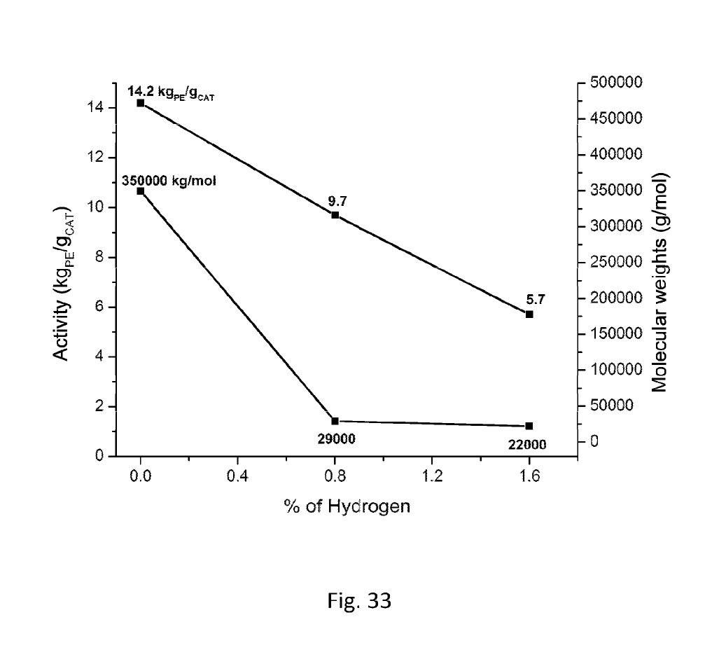

FIG. 33 shows activity and molecular weight vs H₂ content used as co-feed using solid MAO supported/SB(Cp,I*)ZrCl₂. Polymerisation conditions: 0.05 mg of catalyst, 5 mL heptane, 8 bar and 80° C.

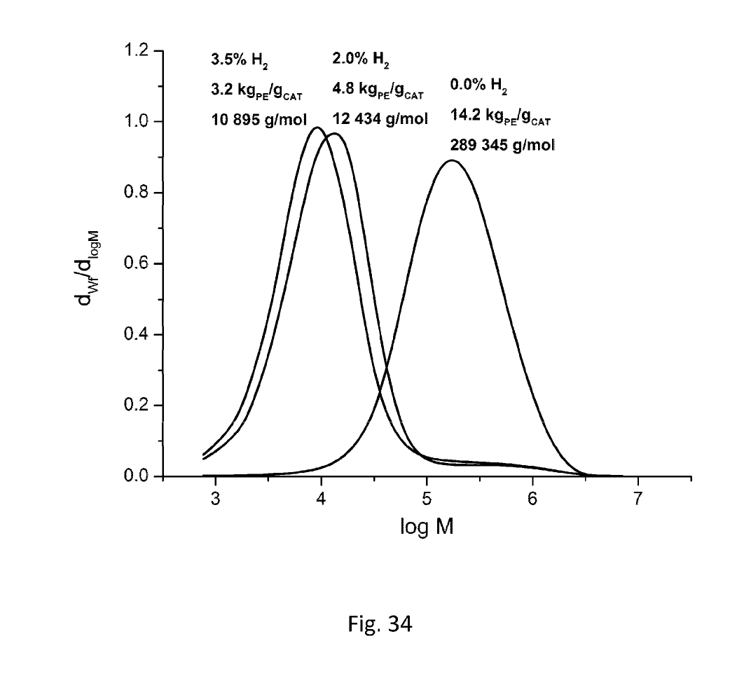

FIG. 34 shows activity and molecular weight vs H₂ content as co-feed using solid MAO supported/SB(Cp,I*)ZrCl₂. Polymerisation conditions: 25 mg of catalyst, 1000 mL hexanes, 8 bar, 80° C., and [TEA]₀/[Zr]₀=300.

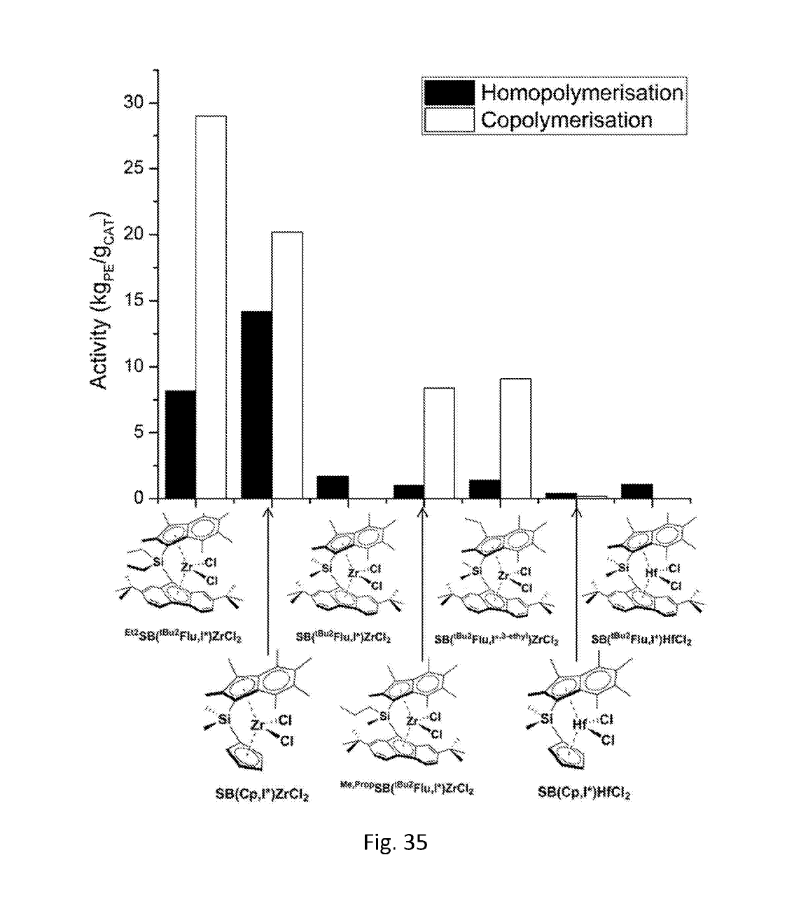

FIG. 35 shows activity of homopolymerisation of ethylene and copolymerisation of ethylene and 1-hexene using solid MAO supported/^{Et2}SB(^{tBu}^{₂}Flu,I*)ZrCl₂, solid MAO supported/SB(Cp,I*)ZrCl₂, solid MAO supported/^{Me,Prop}SB(^{tBu}^{₂}Flu,I*)ZrCl₂, solid MAO supported SB(^{tBu}^{₂}Flu,I*)ZrCl₂, solid MAO supported/SB(^{tBu}^{₂}Flu,I*^{,3-Ethyl})ZrCl₂, solid MAO supported SB(^{tBu}^{₂}Flu,I*)HfCl₂, and solid MAO supported/SB(Cp,I*)HfCl₂. Polymerisation conditions: 0.05 mg of catalyst, 5 mL heptane, 8 bar and 80° C.

### NOMENCLATURE

The nomenclature used herein will be readily understood by the skilled person having regard to the relevant structural formulae. Various abbreviations used throughout are expanded below:

SB means (Me)₂Si-bridged. Similarly, ^{Et2}SB means (Et)₂Si-bridged
EB means ethylene-bridged
Ind* or I* means per-methyl indenyl
Flu means fluorenyl
tBu means tert-butyl
Me means methyl
Pr means propyl
iPr means isopropyl
Ph means phenyl

### General Methodology

All organometallic manipulations were performed under an atmosphere of N₂ using standard Schlenk line techniques or a MBraun UNIlab glovebox, unless stated otherwise. All organic reactions were carried out under air unless stated otherwise. Solvents used were dried by either reflux over sodium-benzophenone diketyl (THF), or passage through activated alumina (hexane, Et₂O, toluene, CH₂Cl₂) using a MBraun SPS-800 solvent system. Solvents were stored in dried glass ampoules, and thoroughly degassed bypassage of a stream of N₂ gas through the liquid and tested with a standard sodium-benzophenone-THF solution before use. Deuterated solvents for NMR spectroscopy of oxygen or moisture sensitive materials were treated as follows: C₆D₆ was freeze-pump-thaw degassed and dried over a K mirror; d⁵-pyridine and CDCl₃ were dried by reflux over calcium hydride and purified by trap-to-trap distillation; and CD₂Cl₂ was dried over 3 Å molecular sieves.

¹H and ¹³C NMR spectroscopy were performed using a Varian 300 MHz spectrometer and recorded at 300 K unless stated otherwise. ¹H and ¹³C NMR spectra were referenced via the residual protio solvent peak. Oxygen or moisture sensitive samples were prepared using dried and degassed solvents under an inert atmosphere in a glovebox, and were sealed in Wilmad 5 mm 505-PS-7 tubes fitted with Young's type concentric stopcocks.

Mass spectra were using a Bruker FT-ICR-MS Apex III spectrometer.

For Single-crystal X-ray diffraction in each case, a typical crystal was mounted on a glass fibre using the oil drop technique, with perfluoropolyether oil and cooled rapidly to 150 K in a stream of N₂ using an Oxford Cryosystems Cryostream¹. Diffraction data were measured using an Enraf-Nonius KappaCCD diffractometer (graphite-monochromated MoKα radiation, λ=0.71073 Å). Series of ω-scans were generally performed to provide sufficient data in each case to a maximum resolution of 0.77 Å. Data collection and cell refinement were carried out using DENZO-SMN². Intensity data were processed and corrected for absorption effects by the multi-scan method, based on multiple scans of identical and Laue equivalent reflections using SCALEPACK (within DENZO-SMN). Structure solution was carried out with direct methods using the program SIR92³. within the CRYSTALS software suite⁴. In general, coordinates and anisotropic displacement parameters of all non-hydrogen atoms were refined freely except where this was not possible due to the presence of disorder. Hydrogen atoms were generally visible in the difference map and were treated in the usual manner⁵.

High temperature gel permeation chromatography were performed using a Polymer Laboratories GPC220 instrument, with one PLgel Olexis guard plus two Olexis 30 cm×13 μm columns. The solvent used was 1,2,4-trichlorobenzene with anti-oxidant, at a nominal flow rate of 1.0 mLmin⁻¹ and nominal temperature of 160° C. Refractive index and Viscotek differential pressure detectors were used. The data were collected and analysed using Polymer Laboratories “Cirrus” software. A single solution of each sample was prepared by adding 15 mL of solvent to 15 mg of sample and heating at 190° C. for 20 minutes, with shaking to dissolve. The sample solutions were filtered through a glass-fibre filter and part of the filtered solutions were then transferred to glass sample vials. After an initial delay of 30 minutes in a heated sample compartment to allow the sample to equilibrate thermally, injection of part of the contents of each vial was carried out automatically. The samples appeared to be completely soluble and there were no problems with either the filtration or the chromatography of the solutions. The GPC system was calibrated with Polymer Laboratories polystyrene calibrants. The calibration was carried out in such a manner that combined GPC-viscosity could be used to give ‘true’ molecular weight data and conventional GPC could also be applied. For the conventional GPC results, the system is calibrated with linear polyethylene or linear polypropylene. This correction has previously been shown to give good estimates of the true molecular weights for the linear polymers.

### Synthesis of Unsymmetrical Pro-Ligands

Synthesis of Ethylene-Bridged [EB(^{tBu}^{₂}Flu,I*)H₂]

Having regard to Scheme 1 shown below, reaction of one equivalent of [(Ind^{#})H] with an excess of 1,2-dibromoethane afforded [(Ind*)CH₂CH₂Br] which was reacted with one equivalent of [(^{tBu}^{₂}Flu)Li] to afford the new ethylene-bridged pro-ligand, [EB(^{tBu}^{₂}Flu,I*)H₂], as a colourless solid in good yield. FIG. 1 provides the ¹H NMR spectrum for EB(^{tBu}^{₂}Flu,I*)H₂].

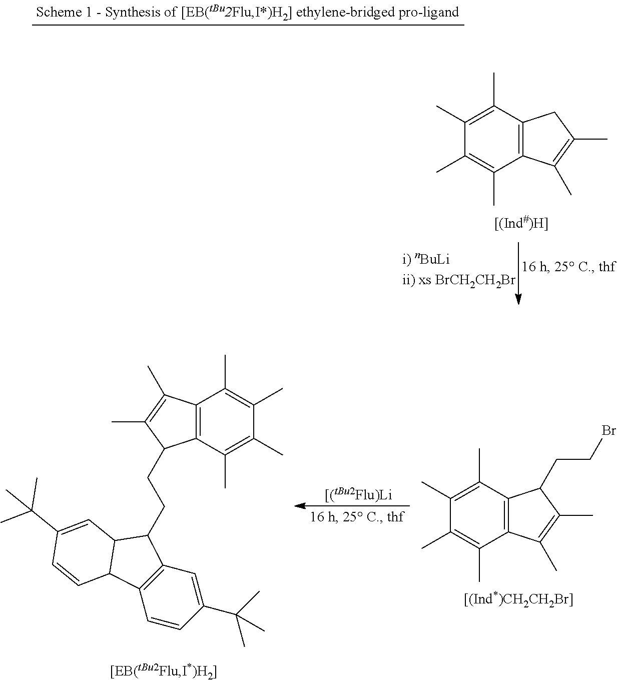

Synthesis of Silicon-Bridged [SB(^{tBu}^{₂}Flu,I*)H₂], [SB(Flu,I*)H₂] and [SB(^{Me,Ph}Ind,I*)H₂]

Having regard to Scheme 2 shown below, various silicon-bridged unsymmetrical pro-ligands were accessed using the silane synthon, [^{R,R′}Si(Ind*)Cl]. FIGS. 2, 3 and 4 show the ¹H NMR spectra for [^{Me}^{₂}Si(Ind*)Cl], [^{iPr}^{₂}Si(Ind*)Cl] and [^{Me,Pr}Si(Ind*)Cl] respectively.

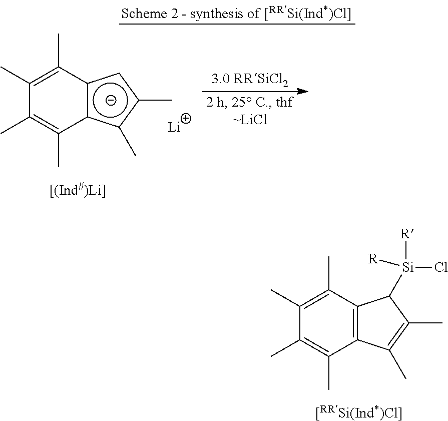

Having regard to Scheme 3 shown below, the synthesised silane synthon [^{Me}^{₂}Si(Ind*)Cl] was separately reacted with one equivalent of [(^{tBu}^{₂}Flu)Li], [(Flu)Li], and [(^{Me,Ph}Ind)Li] to afford the new Si-bridged pro-ligands [SB(^{tBu}^{₂}Flu,I*)H₂], [SB(Flu,I*)H₂] and [SB(^{Me,Ph}Ind,I*)H₂] respectively as colourless solids in very good yields. FIG. 5 shows the ¹H NMR spectrum for [SB(Flu,I*)H₂]. FIG. 6 shows the X-ray crystallographic structure for [SB(^{tBu}^{₂}Flu,I*)H₂].

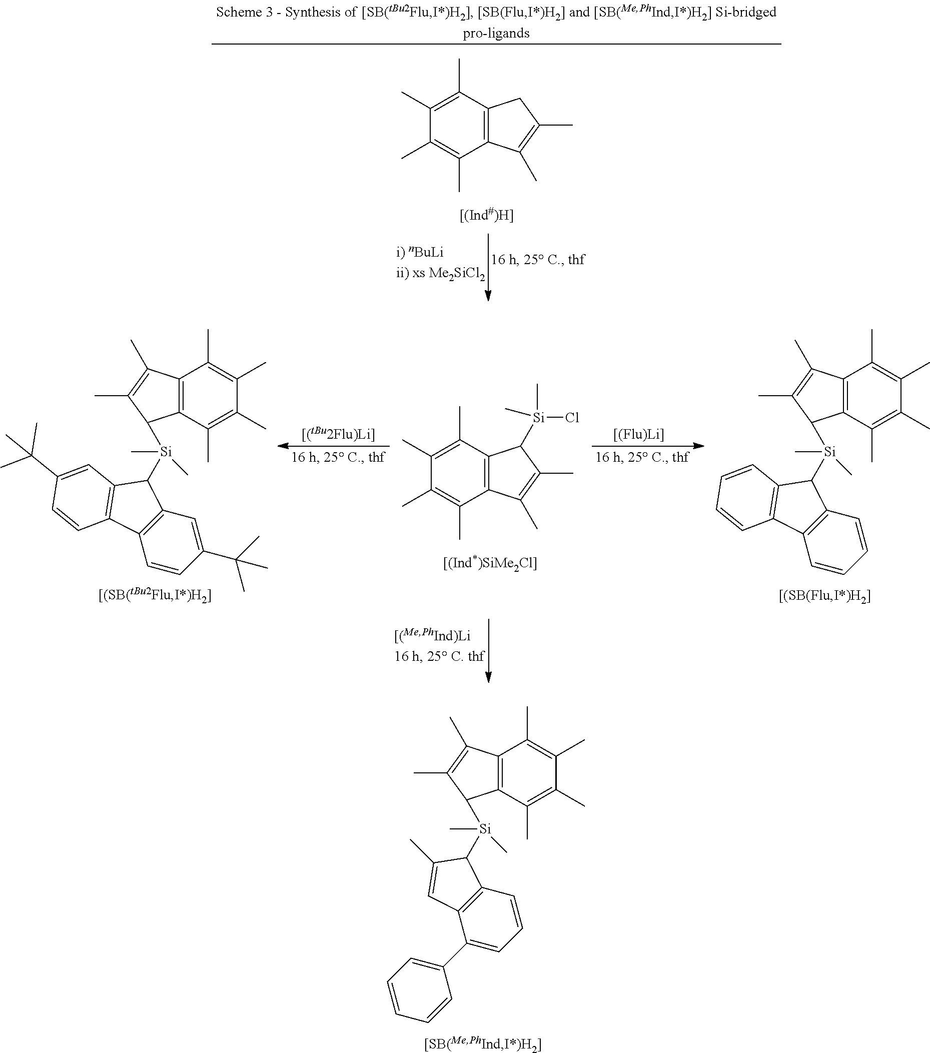

### Synthesis of Unsymmetrical Pro-Catalysts

Synthesis of [SB(^{tBu}^{₂}Flu,I*)ZrCl₂] and [SB(^{tBu}^{₂}Flu,I*)HfCl₂]

Having regard to Scheme 4 shown below, stoichiometric reactions of [SB(^{tBu}^{₂}Flu,I*)Li₂] with MCl₄ (M=Zr and Hf) were carried out in benzene at room temperature overnight to afford [SB(^{tBu}^{₂}Flu,I*)MCl₂] as bright orange solids in good yields. FIGS. 7 and 8 show the ¹H NMR spectra of [SB(^{tBu}^{₂}Flu,I*)ZrCl₂] and [SB(^{tBu}^{₂}Flu,I*)HfCl₂] respectively. Single crystals of [SB(^{tBu}^{₂}Flu,I*)ZrCl₂] and [SB(^{tBu}^{₂}Flu,I*)HfCl₂] suitable for X-ray crystallography were obtained by crystallisation in n-hexane solution at −30° C. FIGS. 9 and 10 show the X-ray crystallographic structures for [SB(^{tBu}^{₂}Flu,I*)ZrCl₂] and [SB(^{tBu}^{₂}Flu,I*)HfCl₂] respectively

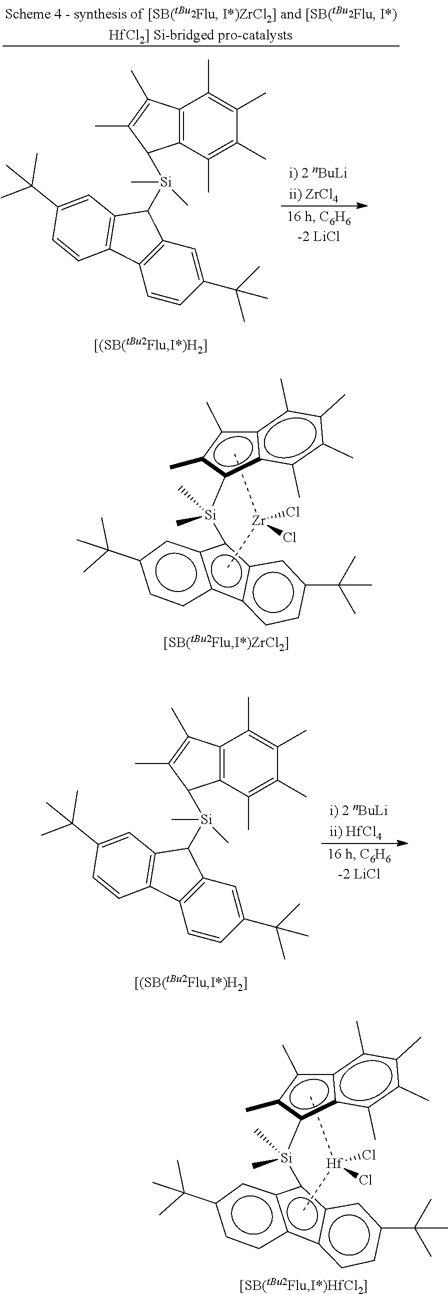

Synthesis of ^{Et2}SB(^{tBu}^{₂}Flu,I*)ZrCl₂ and ^{Me,Prop}SB(^{tBu}^{₂}Flu,I*)ZrCl₂

Having regard to Scheme 5 outlined below, ^{Et2}SB(^{tBu}^{₂}Flu,I*)ZrCl₂ and ^{Me,Prop}SB(^{tBu}^{₂}Flu,I*)ZrCl₂ Si-bridged Zr pro-catalysts were prepared in 18% and 41% yields respectively.

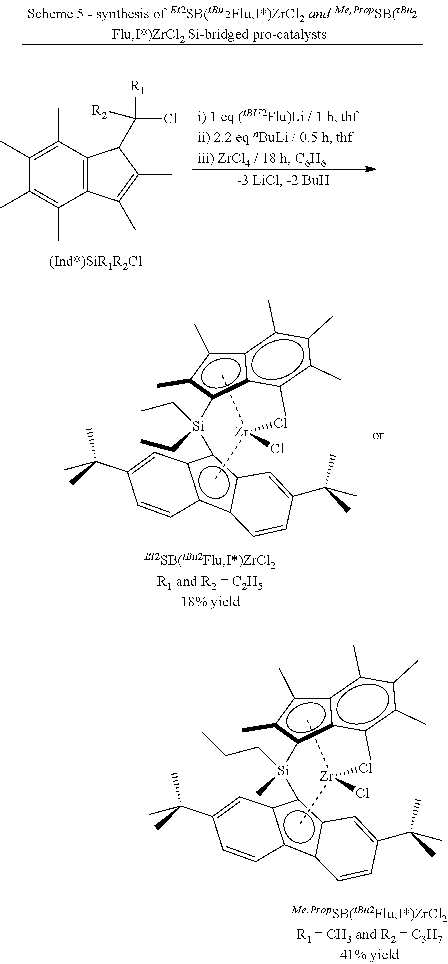

Synthesis of SB(^{tBu}^{₂}Flu,I*^{,3-Ethyl)ZrCl}₂

Having regard to Scheme 6 outlined below, SB(^{tBu}^{₂}Flu,I*,^{3-Ethyl})ZrCl₂ Si-bridged Zr pro-catalyst was prepared.

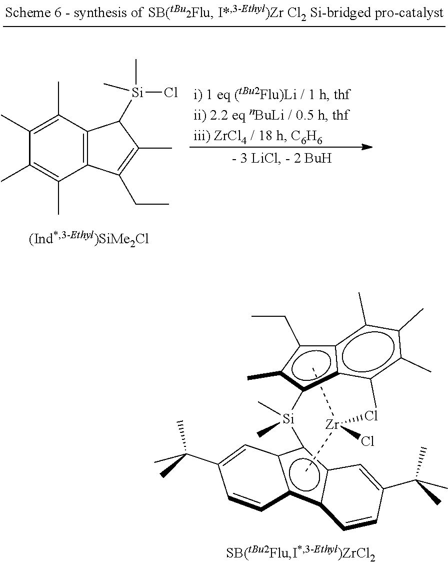

### Synthesis of SB(Cp,I*)ZrCl₂

Having regard to Scheme 7 below, toluene (40 ml) was added to a LiCp (246 mg, 3.41 mmol) and Ind*SiMe2Cl (1 g, 3.41 mmol) in a Schlenk tube, dissolved in −5° C. THF (50 mL) and left to stir for two hours. ⁿBuLi (4.7 mL, 1.6 M in hexanes, 7.51 mmol) was added, dropwise, over 30 minutes and the reaction left to stir for 12 hours. The solvent was removed in vacuo and the residue washed with pentane (3×40 mL) and dried to afford a grey powder. One equivalent of ZrCl₄ (796 mg, 3.41 mmol) was added and the mixture dissolved in benzene and left to stir for sixty hours. The solution changed colour from green, to orange and finally red/brown. The solvent was removed under vacuum and the product extracted with pentane (3×40 mL) and filtered through Celite. The filtrate was concentrated in vacuo and stored at −34° C. This yielded SB(Cp,I*)ZrCl₂ as an orange/brown precipitate in 23% yield (365 mg, 0.76 mmol). Orange crystals, suitable for single crystal X-ray diffraction, were grown from a concentrated solution in hexanes at −34° C.

¹H NMR (d₆-benzene): δ 6.59 (2H, dm, CpH), 5.60 (2H, dm, CpH), 2.52 (3H, s, ArMe), 2.48 (3H, s, ArMe), 2.26 (3H, s, ArMe), 2.15 (3H, s, ArMe), 2.05 (3H, s, ArMe), 1.97 (3H, s, ArMe), 0.72 (3H, s, SiMe), 0.64 (3H, s, SiMe).

¹³C{¹H} NMR (d₆-benzene): δ 135.65 (Ar), 135.13 (Ar), 134.86 (Ar), 131.11 (Ar), 131.50 (Ar), 131.15 (Ar), 129.16 (Ar), 126.35 (Ar), 125.92 (ArSi), 115.87 (CpH), 106.49 (CpH), 84.01 (CpSi), 21.69 (ArMe), 17.91 (ArMe), 17.64 (ArMe), 17.16 (ArMe), 16.92 (ArMe), 15.97 (ArMe), 5.59 (SiMe), 3.26 (SiMe).

MS (EI): Predicted: m/z 482.0372. Observed: m/z 482.0371. IR (KBr) (cm⁻¹): 2961, 2925, 1543, 1260, 1029, 809, 668.

CHN Analysis (%): Expected: C, 54.74, H, 5.85. Found: C, 54.85, H, 5.94.

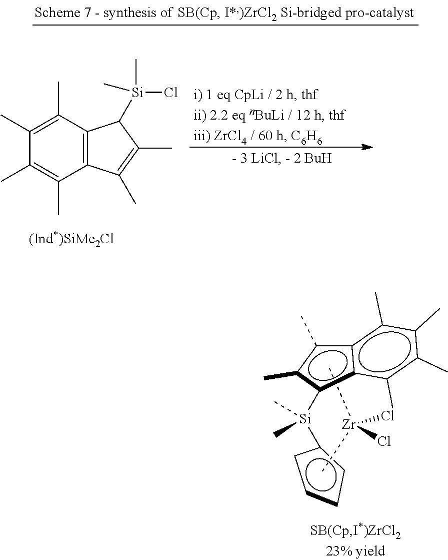

### Synthesis of SB(Cp,I*)HfCl₂

Having regard to Scheme 8 below, SB(Cp,I*)Li₂ (1 g, 2.99 mmol) and HfCl₄ (958 mg, 2.99 mmol) were added to a Schlenk tube. Benzene (100 mL) was added and the reaction was left to stir for 60 hours. The solution changed colour from brown to yellow. The solvent was the removed under vacuum and the product was extracted with pentane (3×40 mL) and filtered through Celite. The filtrate was concentrated in vacuo and stored at −34° C. yielding SB(Cp,I*)HfCl₂ as yellow crystals, suitable for single crystal X-ray diffraction, in 24% yield (360 mg, 0.632 mmol).

¹H NMR (d₆-benzene): δ 6.54 (3H, dm, CpH), 5.53 (3H, dm, CpH), 2.57 (3H, s, ArMe), 2.56 (3H, s, ArMe), 2.25 (3H, s, ArMe), 2.20 (3H, s, ArMe), 2.09 (3H, s, ArMe), 2.03 (3H, s, ArMe), 0.65 (3H, s, SiMe), 0.57 (3H, s, SiMe).

¹³C{¹H} NMR (d₆-benzene): δ 134.55 (Ar), 134.18 (Ar), 133.51 (Ar), 131.73 (Ar), 131.05 (Ar), 129.64 (Ar), 126.23 (Ar), 125.18 (Ar), 124.38 (Ar), 113.33 (CₚH), 107.32 (CₚH), 82.33 (CₚSi), 21.53 (ArMe), 17.68 (ArMe), 17.37 (ArMe), 16.77 (ArMe), 16.64 (ArMe), 15.51 (ArMe), 5.00 (SiMe), 3.00 (SiMe).

MS (EI): Predicted: m/z 570.0785. Observed: m/z 570.0701. IR (KBr) (cm⁻¹): 2960, 2923, 1542, 1262, 1028, 812, 670.

CHN Analysis (%): Expected: C, 46.36, H, 4.95. Found: C, 46.52, H, 5.04.

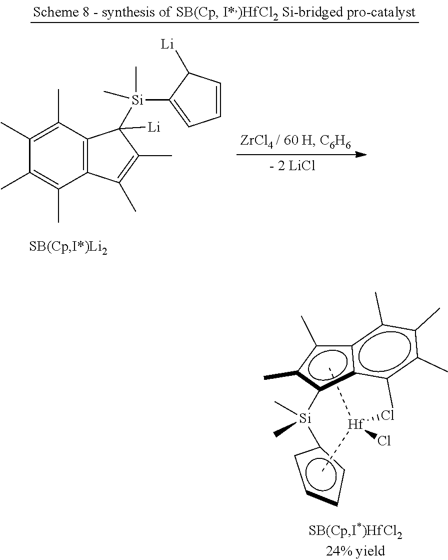

Synthesis of SB(Cp,I*)ZrCl(O-Me₂-C₆H₃)

Having regard to Scheme 9 below, SB(Cp,I*)ZrCl₂ (100 mg, 0.207 mmol) and 2,6-dimethyl potassium phenoxide (66 mg, 0.414 mmol) were added to a Schlenk tube, dissolved in benzene (20 mL), and left to stir for sixteen hours. The solvent was removed in vacuo and the product extracted with pentane (2×20 mL). The ¹H NMR spectra showed resonances corresponding to a mixture of two isomers. Thin, yellow crystals of isomer (a), suitable for single crystal X-ray diffraction were obtained when the solution was concentrated and stored in a −34° C. freezer. Purity was 94% by ¹H NMR spectroscopy and crystals were obtained in 15% yield (16 mg, 0.028 mmol).

Isomer (a):

¹H NMR (d₆-benzene): δ 7.06 (2H, dd, ArₚₕₑₙH), 6.82 (1H, t, ArₚₕₑₙH), 6.26 (1H, m, CpH), 6.13 (1H, m, CpH), 5.93 (1H, m, CpH), 5.61 (1H, m, CpH), 2.34 (3H, s, ArMe), 2.24 (3H, s, ArMe), 2.22 (6H, s, Arₚₕₑₙ Me), 2.19 (3H, s, ArMe), 2.18 (3H, s, ArMe), 2.15 (3H, s, ArMe), 1.99 (3H, s, ArMe), 0.81 (3H, s, SiMe), 0.75 (3H, s, SiMe).

Isomer (b):

¹H NMR (d₆-benzene): δ 6.88 (2H, dd, ArₚₕₑₙH), 6.69 (1H, t, ArₚₕₑₙH), 6.51 (1H, m, CpH), 6.02 (1H, m, CpH), 5.88 (1H, m, CpH), 5.80 (1H, m, CpH), 2.61 (3H, s, ArMe), 2.42 (6H, s, Arₚₕₑₙ Me), 2.40 (3H, s, ArMe), 2.08 (3H, s, ArMe), 1.99 (3H, s, ArMe), 1.64 (3H, s, ArMe), 1.48 (3H, s, ArMe), 0.64 (3H, s, SiMe), 0.61 (3H, s, SiMe).

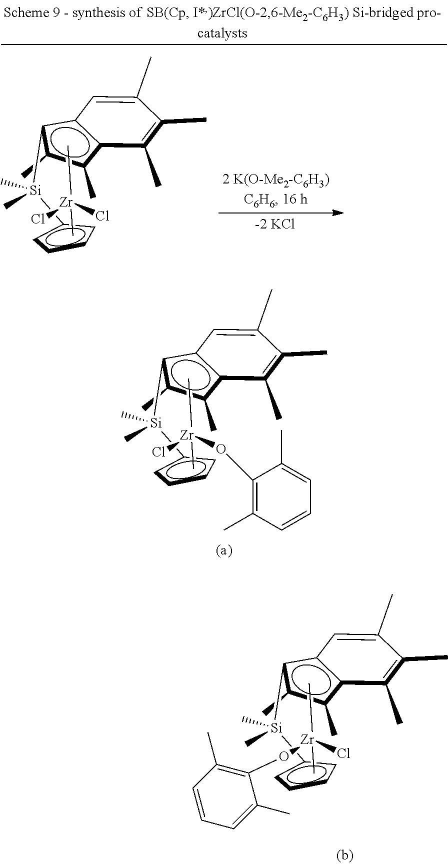

### Synthesis of Supported Catalyst Systems

Synthesis of solid MAO/SB(^{tBu}^{₂}Flu,I*)ZrCl₂] Catalyst System

Toluene (40 ml) was added to a Schlenk tube containing solid aluminoxane (solid MAO) (produced by TOSOH, Lot no. TY130408) (400 mg) and [SB(^{tBu}^{₂}Flu,I*)ZrCl₂] (shown below) (13.6 mg) at room temperature. The slurry was heated to 60° C. and left, with occasional swirling, for one hour during which time the solution turned colourless and the solid colourised dark green. The resulting suspension was then left to cool down to room temperature and the toluene solvent was carefully filtered and removed in vacuo to obtain solid MAO/[SB(^{tBu}^{₂}Flu,I*)ZrCl₂] catalyst as a grey, free-flowing powder in 85% yield (352 mg).

### Synthesis of Solid MAO/rac-[(EBI*)ZrCl₂], Catalyst System (Comparative Example)

Toluene (40 ml) was added to a Schlenk tube containing solid MAO (produced by TOSOH; Lot no. TY130408) (400 mg) and rac-[(EBI*)ZrCl₂] (shown below) (8.6 mg) at room temperature. The slurry was heated to 60° C. and left, with occasional swirling, for one hour during which time the solution turned colourless and the solid colourised dark green. The resulting suspension was then left to cool down to room temperature and the toluene solvent was carefully filtered and removed in vacuo to obtain solid MAO/[SB(^{tBu}^{₂}Flu,I*)ZrCl₂] catalyst as a grey, free-flowing powder in 85% yield (352 mg).

### Synthesis of Solid MAO/meso-[(EBI*)ZrO₂] Catalyst System (Comparative Example)

Toluene (40 ml) was added to a Schlenk tube containing solid MAO (produced by TOSOH; Lot no. TY130408) (400 mg) and meso-[(EBI*)ZrCl₂] (shown below) (8.6 mg) at room temperature. The slurry was heated to 60° C. and left, with occasional swirling, for one hour during which time the solution turned colourless and the solid colourised dark green. The resulting suspension was then left to cool down to room temperature and the toluene solvent was carefully filtered and removed in vacuo to obtain solid MAO/[SB(^{tBu}^{₂}Flu,I*)ZrCl₂] catalyst as a grey, free-flowing powder in 85% yield (352 mg).

### Synthesis of Solid MAO/rac-[(SBI*)ZrCl₂] Catalyst System (Comparative Example)

Toluene (40 ml) was added to a Schlenk tube containing solid MAO (produced by TOSOH; Lot no. TY130408) (400 mg) and rac-[(SBI*)ZrCl₂] (shown below) (9.1 mg) at room temperature. The slurry was heated to 60° C. and left, with occasional swirling, for one hour during which time the solution turned colourless and the solid colourised dark green. The resulting suspension was then left to cool down to room temperature and the toluene solvent was carefully filtered and removed in vacuo to obtain solid MAO/[SB(^{tBu}^{₂}Flu,I*)ZrCl₂] catalyst as a grey, free-flowing powder in 85% yield (352 mg).

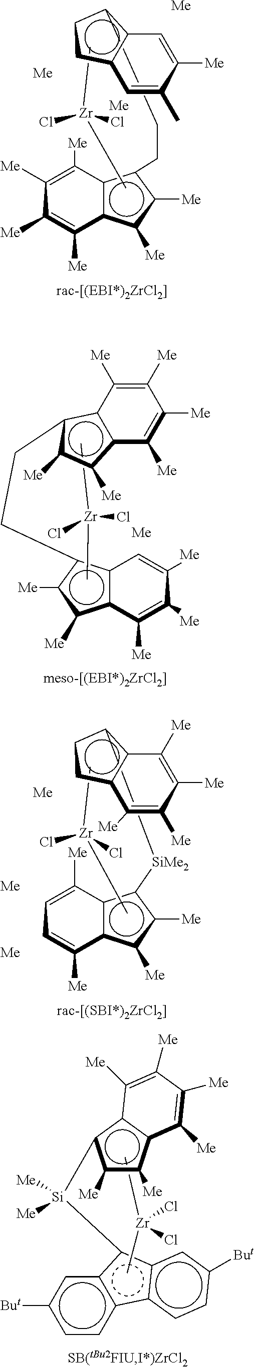

### Ethylene Polymerisation Studies

### Homopolymerisation of Ethylene

Solid MAO/[Zr-Complex] catalysts (Zr-Complex=rac-[(EBI*)ZrCl₂], meso-[(EBI*)ZrCl₂], rac-[(SBI*)ZrCl₂], [SB(^{tBu}^{₂}Flu,I*)ZrCl₂]) were tested for their ethylene homopolymerisation activity under slurry conditions in the presence of tri(isobutyl)aluminium (TIBA), an aluminium-based scavenger. The reactions were performed under 2 bar of ethylene in a 200 mL ampoule, with 10 mg of the catalyst suspended in 50 mL of hexane. The reactions were run for 60 minutes controlled by heating in an oil bath. The resulting polyethylene was immediately filtered under vacuum through a dry sintered glass frit. The polyethylene product was then washed with pentane (2×25 ml) and then dried on the frit for at least one hour. The tests were carried out at least twice for each individual set of polymerisation conditions.

FIG. 11 shows the polymerisation productivity (Kg(PE)g(Cat)⁻¹h⁻¹) vs time (sec) for the polymerisation of ethylene using Solid MAO based catalysts at 70° C. FIG. 12 shows the polymerisation productivity (Kg(PE)g(Cat)⁻¹h⁻¹) vs time (sec) for the polymerisation of ethylene using Solid MAO based catalysts at 80° C. The data demonstrate markedly superior activity for the solid MAO/[SB(^{tBu}^{₂}Flu,I*)ZrCl₂] catalyst system of the invention, when compared with comparative examples solid MAO/rac-[(EBI*)ZrCl₂], solid MAO/meso-[(EBI*)ZrCl₂] and solid MAO/rac-[(SBI*)ZrCl₂].

Table 1 below shows GPC results for the homopolymerisation of ethylene using Solid MAO/[complex] (complex=rac-[(EBI*)ZrCl₂], meso-[(EBI*)ZrCl₂], rac-[(SBI*)ZrCl₂], [SB(^{tBu}^{₂}Flu,I*)ZrCl₂]).

TABLE 1
GPC results for the homopolymerisation of ethylene using
Solid MAO/[complex].
Polymerisation conditions:
5 mL heptane, P_{ethylene} = 120 psi, and n_{(TEA)} = 10 μmol.

| | | | T = 80° C. | |
|---|---|---|---|---|
| | T = 70° C. | | M_{w} | M_{w}/ |
| Catalyst | M_{w} (kDa) | M_{w}/Mₙ | (kDa) | Mₙ |
| Solid MAO/rac-[(EBI*)ZrCl₂] | 199 | 2.3 | 194 | 2.7 |
| Solid MAO/meso-[(EBI*)ZrCl₂] | 242 | 2.7 | 210 | 2.7 |
| Solid MAO/rac-[(SBI*)ZrCl₂] | 273 | 3.1 | 367 | 3.3 |
| Solid MAO/[SB(^{tBu}₂Flu,I*)ZrCl₂] | 722† | 3.5 | 626† | 3.6 |

†Values underestimated due to incomplete sample elution.
Note:
maximum error is 10% on M_{w}.

Having regard to the data presented in Table 1, unsymmetrical complex [SB(^{tBu}^{₂}Flu,I*)ZrCl₂] is seen to afford polyethylene having a significantly higher molecular weight than that afforded by the comparator catalyst systems. Moreover, the increase in molecular weight is not accompanied by an increase in polydispersity. High molecular weight materials with low polydispersity are highly favoured by industry in special applications.

### Copolymerisation of Ethylene and 1-Hexene

Solid MAO/[Zr-Complex] catalysts (Zr-Complex=rac-[(EBI*)ZrCl₂], meso-[(EBI*)ZrCl₂], rac-[(SBI*)ZrCl₂], [SB(^{tBu}^{₂}Flu,I*)ZrCl₂]) were tested for their ethylene/1-hexene copolymerisation activity under slurry conditions in the presence of tri(isobutyl)aluminium (TIBA), an aluminium-based scavenger. The reactions were performed under 2 bar of ethylene in a 200 mL ampoule, with 10 mg of the catalyst suspended in 50 mL of hexane. The reactions were run for 60 minutes controlled by heating in an oil bath. The resulting polyethylene was immediately filtered under vacuum through a dry sintered glass frit. The polyethylene product was then washed with pentane (2×25 ml) and then dried on the frit for at least one hour. The tests were carried out at least twice for each individual set of polymerisation conditions.

FIG. 13 shows activity vs. time for the copolymerisation of ethylene and 1-hexene using Solid MAO based catalyst. FIG. 14 shows activity vs time for the copolymerisation of ethylene and 1-hexene using Solid MAO based catalyst with variation of the 1-hexene feed, when P_{ethylene}=120 PSI. FIG. 15 shows activity vs time for the copolymerisation of ethylene and 1-hexene using Solid MAO based catalyst with variation of the 1-hexene feed, when P_{ethylene}=80 PSI. The data demonstrate superior copolymerisation activity for the solid MAO/[SB(^{tBu}^{₂}Flu,I*)ZrCl₂] catalyst system of the invention, when compared with comparative examples solid MAO/rac-[(EBI*)ZrCl₂], solid MAO/meso-[(EBI*)ZrO₂] and solid MAO/rac-[(SBI*)ZrCl₂].

Table 2 below summarises activity results for the copolymerisation of ethylene and 1-hexene using Solid MAO/[complex].

TABLE 2
Activity results for the copolymerisation of ethylene and 1-hexene using
Solid MAO/[complex].
Polymerisation conditions: 5 mL heptane, T = 70° C.,
P_{ethylene} = 120 psi, and n_{(TEA)} = 15 μmol.

| | [Hexene]_{feed} | | |
|---|---|---|---|
| | 0 vol % | 2 vol % | 5 vol % |
| | Activity | Activity | Activity |
| | kg(cop) | kg(cop) | kg(cop) |
| Catalyst | g(cat)⁻¹ h⁻¹ | g(cat)⁻¹ h⁻¹ | g(cat)⁻¹ h⁻¹ |
| Solid MAO/ | 6.8 | 7.7 | 8.9 |
| rac-[(EBI*)ZrCl₂] | | | |
| Solid MAO/ | 0.3 | 0.3 | 0.3 |
| meso-[(EBI*)ZrCl₂] | | | |
| Solid MAO/ | 6.1 | 7.4 | 6.6 |
| rac-[(SBI*)ZrCl₂] | | | |
| Solid MAO/ | 9.8 | 16.4 | 18.2 |
| [SB(^{tBu}₂Flu,I*)ZrCl₂] | | | |

The results presented in Table 2 demonstrate that the Solid MAO/[SB(^{tBu}^{₂}Flu,I*)ZrCl₂] catalytic complex of the invention exhibits markedly superior activity across a range of hexane concentrations, when compared with comparator catalytic complexes.

Tables 3 and 4 below shows GPC results for the copolymerisation of ethylene and 1-hexene using Solid MAO/[complex] (complex=rac-[(EBI*)ZrCl₂], meso-[(EBI*)ZrCl₂], rac-[(SBI*)ZrCl₂], [SB(^{tBu}^{₂}Flu,I*)ZrCl₂]).

TABLE 3
GPC results for the copolymerisation of ethylene and 1-hexene using
Solid MAO/[complex]. Polymerisation conditions: 5 mL heptane,
T = 70° C., P_{ethylene} = 120 psi, and n_{(TEA)} = 15 μmol.

| | [Hexene]_{feed} = 5 vol % | | [Hexene] = 10 vol % | |
|---|---|---|---|---|
| Catalyst | M_{w} (kDa) | M_{w}/Mₙ | M_{w} (kDa) | M_{w}/Mₙ |
| Solid MAO/ | 227 | 2.5 | 228 | 2.6 |
| rac-[(EBI*)ZrCl₂] | | | | |
| Solid MAO/ | 271 | 3.3 | 224 | 2.8 |
| meso-[(EBI*)ZrCl₂] | | | | |
| Solid MAO/ | 302 | 3.3 | 244 | 2.8 |
| rac-[(SBI*)ZrCl₂] | | | | |
| Solid MAO/ | 270† | 2.1 | 479 | 3.1 |
| [SB(^{tBu}₂Flu,I*)ZrCl₂] | | | | |

†Values underestimated due to incomplete sample elution.
Note:
maximum error is 10% on M_{w}.

TABLE 4
GPC results for the copolymerisation of ethylene and 1-hexene using
Solid MAO/[complex]. Polymerisation conditions: 5 mL heptane,
T = 70° C., P_{ethylene} = 80 psi, and n_{(TEA)} = 15 μmol

| | [Hexene]_{feed} = 2 vol % | | [Hexene] = 5 vol % | |
|---|---|---|---|---|
| Catalyst | M_{w} (kDa) | M_{w}/Mₙ | M_{w} (kDa) | M_{w}/Mₙ |
| Solid MAO/ | 207 | 2.3 | 231 | 2.6 |
| rac-[(EBI*)ZrCl₂] | | | | |
| Solid MAO/ | 213 | 2.7 | 212 | 2.8 |
| meso-[(EBI*)ZrCl₂] | | | | |
| Solid MAO/ | 378 | 4.2 | 311 | 3.5 |
| rac-[(SBI*)ZrCl₂] | | | | |
| Solid MAO/ | 310* | 3.0 | 235* | 1.3 |
| [SB(^{tBu}₂Flu,I*)ZrCl₂] | | | | |

Table 5 below illustrates the incorporation of 1-hexene in the copolymerisation of ethylene and 1-hexene by ¹³C{¹H} NMR spectroscopy and crystallization elution fractionation analysis.

TABLE 5
¹³C{¹H} NMR spectroscopy and CEF results of the incorporation of
1-hexene in the copolymerisation of ethylene and 1-hexene using
Solid MAO/[complex]. Polymerisation conditions: 5 mL heptane,
T = 70° C., P_{ethylene} = 120 psi, and n_{(TEA)} = 15 μmol.

| | [Hexene]_{feed} | [Hexene]_{cop} | T_{el,max} | IV |
|---|---|---|---|---|
| Catalyst | (% v/v) | (mol %) | (° C.) | (dL/g) |
| Solid MAO/ | 5 | 0.2 | 110.7 | 1.9 |
| rac-[(EBI*)ZrCl₂] | 10 | 0.4 | 109.9 | 2.0 |
| Solid MAO/ | 5 | 0.2 | 110.4 | 2.0 |
| meso-[(EBI*)ZrCl₂] | 10 | 0.5 | 109.6 | 1.8 |
| Solid MAO/ | 5 | 0.4 | 108.4 | 1.7 |
| rac-[(SBI*)ZrCl₂] | 10 | 0.8 | 108.8 | 1.9 |
| Solid MAO/ | 5 | 2.0 | — | — |
| [SB(^{tBu}₂Flu,I*)ZrCl₂] | 10 | 3.8 | 96.6 | 3.6 |

The results outlined in Tables 3-5 point to a well-behaved copolymerization process with narrow inter-molecular co-monomer distribution, as analysed by GPC and CEF.

### Further Polymerisation Studies

Table 6 below presents the activity results (kg_{PE}/g_{CAT}/h) for the polymerisation of ethylene in slurry using SB(Cp,I*)ZrCl₂ supported on Solid MAO. The activity of this complex is compared with that of (^{nBu}Cp)₂ZrCl₂ and (Ind)₂ZrCl₂, when supported on solid MAO, which are not encompassed by the invention.

TABLE 6
Activity results (kg_{PE}/g_{CAT}/h) for the polymerisation
of ethylene in slurry, complex supported on Solid MAO

| | T | P | Time | V | Activity |
|---|---|---|---|---|---|
| Complex | (° C.) | (bar) | (minutes) | (mL) | kg_{PE}/g_{CAT}/h |
| SB(Cp,I*)ZrCl₂ | 80 | 8 | 70 | 1000 | 3.2 |
| (^{nBu}Cp)₂ZrCl₂ | 80 | 8 | 70 | 1000 | 1.2 |
| (Ind)₂ZrCl₂ | 80 | 8 | 70 | 1000 | 1.6 |

Table 7 below presents the activity results (kg_{PE}/g_{CAT}/h) and molecular weight (g/mol) for the polymerisation of ethylene in slurry using supported on Solid MAO/SB(Cp,I*)ZrCl₂ as a function of H₂ feeding content.

TABLE 7
Activity results (kg_{PE}/g_{CAT}/h) and molecular weight (g/mol) for
the polymerisation of ethylene in slurry using supported on Solid
MAO/SB(Cp,I*)ZrCl₂ as a function of H₂ feeding content.

| H₂ | T | P | Time | V | Activity | M_{w} |
|---|---|---|---|---|---|---|
| (%) | (° C.) | (bar) | (minutes) | (mL) | kg_{PE}/g_{CAT}/h | (g/mol) |
| 0 | 80 | 8 | | 5 | 14.2 | 350000 |
| 0.8 | 80 | 8 | | 5 | 9.7 | 29000 |
| 1.6 | 80 | 8 | | 5 | 5.7 | 22000 |
| 0 | 80 | 8 | 60 | 1000 | 14.2 | 289345 |
| 2 | 80 | 8 | 60 | 1000 | 4.8 | 12434 |
| 3.5 | 80 | 8 | 60 | 1000 | 3.2 | 10895 |

Table 8 below presents the activity results (kg_{PE}/g_{CAT}/h/bar), molecular weight (g/mol) and CEF value for the polymerisation of ethylene and co-polymerisation of ethylene and 1-hexene in slurry using various compositions of the invention (supported on Solid MAO).

TABLE 8
Activity results (kg_{PE}/g_{CAT}/h/bar), molecular weight (g/mol) and CEF
value for the polymerisation of ethylene and co-polymerisation of ethylene
and 1-hexene in slurry using complexes supported on Solid MAO.

| | [Hexene]_{feed} | [Hexene]_{cop} | Activity | M_{w} | M_{w}/ | T_{el, max} |
|---|---|---|---|---|---|---|
| Complex | (μL) | (mol %) | kg_{PE}/g_{CAT}/h | (kg/mol) | Mₙ | (° C.) |
| ^{Et2}SB(^{tBu}^{₂}Flu,I*)ZrCl₂ | 0 | 0 | 8.1 | 279000 | 2.9 | 111.5 |
| ^{Et2}SB(^{tBu}^{₂}Flu,I*)ZrCl₂ | 125 | 1.3 | 29.2 | 242000 | 2.8 | 103.5 |
| ^{Et2}SB(^{tBu}^{₂}Flu,I*)ZrCl₂ | 250 | 2.8 | 6.1 | 232000 | 2.1 | 99.1 |
| SB(Cp,I*)ZrCl₂ | 0 | 0 | 14.2 | 73000 | 2.6 | 111.1 |
| SB(Cp,I*)ZrCl₂ | 125 | 0.6 | 20.2 | 85000 | 2.4 | 107.2 |
| SB(Cp,I*)ZrCl₂ | 250 | 1.0 | 18.5 | 60000 | 2.1 | 104.1 |
| ^{Me, Prop}SB(^{tBu}^{₂}Flu,I*)ZrCl₂ | 0 | 0 | 1.0 | 169000 | 3.2 | 111.6 |
| ^{Me, Prop}SB(^{tBu}^{₂}Flu,I*)ZrCl₂ | 250 | 3.2 | 8.4 | 268000 | 2.4 | 98.4 |
| SB(^{tBu}^{₂}Flu,I*^{, 3-Ethyl})ZrCl₂ | 0 | 0 | 1.5 | 171000 | 5.3 | 111.6 |
| SB(^{tBu}^{₂}Flu,I*^{, 3-Ethyl})ZrCl₂ | 250 | 3.6 | 9.1 | 212000 | 2.3 | 95.1 |
| SB(Cp,I*)HfCl₂ | 0 | 0 | 0.5 | 168000 | 2.3 | 111.8 |
| SB(^{tBu}^{₂}Flu,I*)HfCl₂ | 0 | 0 | 1.1 | 318000 | 2.4 | 111.9 |

Polymerisation conditions: 80° C., 8 bar, 5 mL Heptane

FIGS. 28 and 29 demonstrate that the solid MAO supported SB(^{tBu}^{₂}Flu,I*)ZrCl₂ and solid MAO supported SB(Cp,I*)ZrCl₂ catalysts possess the highest activities. Changing the bridge to di-ethyl and methyl-propyl led to similar activities.

FIG. 30 shows that solid MAO supported SB(^{tBu}^{₂}Flu,I*)HfCl₂ is 3 times faster than solid MAO supported SB(Cp,I*)HfCl₂ but 25% slower than its zirconium analogue (FIG. 26).

FIG. 31 shows that good polyethylene morphology were obtained when solid MAO supported/^{Et2}SB(^{tBu}^{₂}Flu,I*)ZrCl₂ and solid MAO supported/SB(Cp,I*)ZrCl₂ were used as catalysts, which demonstrates monodisperse PE.

FIG. 32 shows that in similar conditions solid MAO supported/SB(Cp,I*)ZrCl₂ is better controlled and affords a higher activity (3.2 kg_{PE}/g_{CAT}/h/bar) than known industrial catalysts (solid MAO supported (^{nBu}Cp)₂ZrCl₂ and solid supported (Ind)₂ZrCl₂ with activities of 1.2 and 1.6 kg_{PE}/g_{CAT}/h/bar respectively). This demonstrates the huge potential for solid MAO supported/SB(Cp,I*)ZrCl₂ to be used as catalyst for the formation of PE wax.

FIGS. 33 and 34 show the decrease in activity and in molecular weight with increasing H₂ content when used as co-feed.

FIG. 35 shows that most of the catalysts afforded a higher activity for the copolymerisation of ethylene and 1-hexene than the just for the homopolymerisation of ethylene.

### Synthesis of Solid MAO

Various samples of solid MAO were prepared according to the below synthetic protocol:

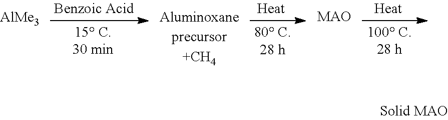

The effect of varying Al:O ratio on the BET surface area and ethylene polymerisation activity was investigated. The results are presented in Table 9 below:

TABLE 9
Effect of varying Al:O ratio on the BET surface area and
ethylene polymerisation activity of
Me₂SB(^{tBu2}Flu, I*)ZrCl₂ supported on solid MAO

| | TMA | | | | |
|---|---|---|---|---|---|
| | Content/ | | BET/ | | Activity/ |
| Al:O | mol % | % yield | m²mmol_{Al}⁻¹ | Supported? | kg_{PE}mol_{zr}⁻¹h⁻¹ |
| 1.0 | 1.0 | 26 | 11.9 | No | — |
| 1.1 | 20.8 | 93 | 16.3 | Yes | 4777 |
| 1.2 | 15.1 | 82 | 15.3 | Yes | 2613 |
| 1.3 | 7.5 | 53 | 10.4 | Yes | 5518 |
| 1.4 | 11.0 | 42 | 9.9 | Yes | 2730 |
| 1.6 | 11.6 | 58 | 8.4 | Yes | — |

TMA amount kept constant.
Benzoic acid content varied.

While specific embodiments of the invention have been described herein for the purpose of reference and illustration, various modifications will be apparent to a person skilled in the art without departing from the scope of the invention as defined by the appended claims.

### REFERENCES

1 J. Cosier, A. M. Glazer, J. Appl. Cryst. 19 (1986) 105
2 Z. Otwinowski, W. Minor, Methods Enzymol. 276 (1997) 307
3 L. Palatinus, G. Chapuis, J. Appl. Cryst. 40 (2007) 786
4 P. W. Betteridge, J. R. Carruthers, R. I. Cooper, K. Prout, D. J. Watkin, J. Appl. Cryst. 36 (2003) 1487
5 R. I. Cooper, A. L. Thompson, D. J. Watkin, J. Appl. Cryst. 43 (2010) 1100

1. A composition comprising a solid methyl aluminoxane support material and compound of the formula (I) shown below: 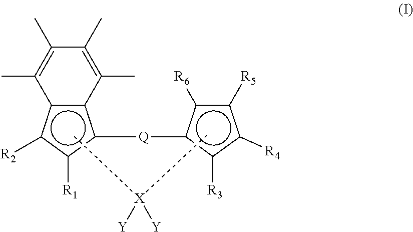
wherein:
R₁ and R₂ are each independently (1-2C)alkyl;
R₃ and R₄ are each independently hydrogen or (1-4C)alkyl, or R₃ and R₄, taken together with the atoms to which they are attached, form a 6-membered fused aromatic ring optionally substituted with one or more groups selected from the group consisting of (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
R₅ and R₆ are each independently hydrogen or (1-4C)alkyl, or R₅ and R₆, taken together with the atoms to which they are attached, form a 6-membered fused aromatic ring optionally substituted with one or more groups selected from the group consisting of (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
Q is a bridging group comprising 1, 2 or 3 bridging atoms selected from the group consisting of C, N, O, S, Ge, Sn, P, B, and Si, or a combination thereof, and is optionally substituted with one or more groups selected from the group consisting of hydroxyl, (1-6C)alkyl, (2-6C)alkenyl, (2-6C)alkynyl, (1-6C)alkoxy and aryl;
X is zirconium, titanium or hafnium; and
each Y group is independently selected from the group consisting of halo, hydrogen, a phosphonate anion, a sulfonate anion, a borate anion, (1-6C)alkyl, (2-6C)alkenyl, (2-6C)alkynyl, (1-6C)alkoxy, aryl, and aryloxy, wherein each of (1-6C)alkyl, (2-6C)alkenyl, (2-6C)alkynyl, (1-6C)alkoxy, aryl, and aryloxy is optionally substituted with one or more groups selected from the group consisting of (1-6C)alkyl, halo, nitro, amino, phenyl, (1-6C)alkoxy, —C(O)NRₓR_{y} and Si[(1-4C)alkyl]₃;
wherein Rₓ and R_{y} are independently (1-4C)alkyl;
with the proviso that:
when R₃ and R₄ are hydrogen or (1-4C)alkyl, R₅ and R₆ are not linked to form a fused 6-membered aromatic ring that is substituted with four methyl groups; and
when R₅ and R₆ are hydrogen or (1-4C)alkyl, R₃ and R₄ are not linked to form a fused 6-membered aromatic ring that is substituted with four methyl groups.

2. The composition according to claim 1, wherein R₃ and R₄ are each independently hydrogen or (1-4C)alkyl, or R₃ and R₄, taken together with the atoms to which they are attached, form a fused 6-membered aromatic ring optionally substituted with one or more groups selected from the group consisting of (1-4C)alkyl, (2-4C)alkenyl, (2-4C)alkynyl, (1-4C)alkoxy, aryl, heteroaryl, carbocyclic and heterocyclic, wherein each aryl, heteroaryl, carbocyclic and heterocyclic group is optionally substituted with one or more groups selected from the group consisting of (1-4C)alkyl, (2-4C)alkenyl, (2-4C)alkynyl, (1-4C)alkoxy, halo, amino, nitro, cyano, (1-4C)alkylamino, [(1-4C)alkyl]₂amino and —S(O)₂(1-4C)alkyl; and
R₅ and R₆ are each independently hydrogen or (1-4C)alkyl, or R₅ an R₆, taken together with the atoms to which they are attached, form a fused 6-membered aromatic ring optionally substituted with one or more groups selected from the group consisting of (1-4C)alkyl, (2-4C)alkenyl, (2-4C)alkynyl, (1-4C)alkoxy, aryl, heteroaryl, carbocyclic and heterocyclic, wherein each aryl, heteroaryl, carbocyclic and heterocyclic group is optionally substituted with one or more groups selected from the group consisting of (1-4C)alkyl, (2-4C)alkenyl, (2-4C)alkynyl, (1-4C)alkoxy, halo, amino, nitro, cyano, (1-4C)alkylamino, [(1-4C)alkyl]₂amino and —S(O)₂(1-4C)alkyl.

3. The composition according to claim 1, wherein
R₃ and R₄ are each independently hydrogen or (1-4C)alkyl, or R₃ and R₄, taken together with the atoms to which they are attached, form a fused 6-membered aromatic ring optionally substituted with one or more groups selected from the group consisting of (1-4C)alkyl, aryl, heteroaryl, carbocyclic and heterocyclic, wherein each aryl, heteroaryl, carbocyclic and heterocyclic group is optionally substituted with one or more groups selected from the group consisting of (1-4C)alkyl, (2-4C)alkenyl, (2-4C)alkynyl, (1-4C)alkoxy, halo, amino and nitro; and
R₅ and R₆ are each independently hydrogen or (1-4C)alkyl, or R₅ and R₆, taken together with the atoms to which they are attached, form a fused 6-membered aromatic ring optionally substituted with one or more groups selected from the group consisting of (1-4C)alkyl, aryl, heteroaryl, carbocyclic and heterocyclic, wherein each aryl, heteroaryl, carbocyclic and heterocyclic group is optionally substituted with one or more groups selected from the group consisting of (1-4C)alkyl, (2-4C)alkenyl, (2-4C)alkynyl, (1-4C)alkoxy, halo, amino and nitro.

4. (canceled)

5. The composition according to claim 1, wherein
R₃ and R₄ are each independently hydrogen or (1-4C)alkyl, or R₃ and R₄, taken together with the atoms to which they are attached, form a fused 6-membered aromatic ring optionally substituted with one or more groups selected from the group consisting of (1-4C)alkyl and phenyl, wherein each phenyl group is optionally substituted with one or more groups selected from the group consisting of (1-4C)alkyl, (2-4C)alkenyl, (2-4C)alkynyl, (1-4C)alkoxy, halo, amino and nitro; and
R₅ and R₆ are each independently hydrogen or (1-4C)alkyl, or R₅ and R₆, taken together with the atoms to which they are attached, form a fused 6-membered aromatic ring optionally substituted with one or more groups selected from the group consisting of (1-4C)alkyl and phenyl, wherein each phenyl group is optionally substituted with one or more groups selected from the group consisting of (1-4C)alkyl, (2-4C)alkenyl, (2-4C)alkynyl, (1-4C)alkoxy, halo, amino and nitro.

6. The composition according to claim 1, wherein:
when R₃ and R₄ are hydrogen or (1-4C)alkyl, and R₅ and R₆ are taken together with the carbon atoms to which they are attached to form a fused 6-membered aromatic ring, said ring is optionally substituted with one or two substituents selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl; or
when R₅ and R₆ are hydrogen or (1-4C)alkyl, and R₃ and R₄ are taken together with the carbon atoms to which they are attached to form a fused 6-membered aromatic ring, said ring is optionally substituted with one or two substituents selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl.

7. The composition according to claim 1, wherein Q is a bridging group comprising 1, 2 or 3 bridging atoms selected from the group consisting of C, and Si, or a combination thereof, and is optionally substituted with one or more groups selected from hydroxyl, (1-6C)alkyl, (2-6C)alkenyl, (2-6C)alkynyl, (1-6C)alkoxy and aryl.

8. The composition according to claim 7, wherein Q is a bridging group selected from —[C(Rₐ)(R_{b})—C(R_{c})(R_{d})]— and —[Si(Rₑ)(R_{f})]—, wherein Rₐ, R_{b}, R_{c}, R_{d}, Rₑ and R_{f} are independently selected from hydrogen, hydroxyl, (1-6C)alkyl, (2-6C)alkenyl, (2-6C)alkynyl, (1-6C)alkoxy and aryl.

9. The composition according to claim 8, wherein Rₐ, R_{b}, R_{c} and R_{d} are each hydrogen, and Rₑ and R_{f} are each independently (1-6C)alkyl, (2-6C)alkenyl or phenyl.

10. The composition according to claim 8, wherein Q is a bridging group —[Si(Rₑ)(R_{f})]—, wherein Rₑ and R_{f} are each independently methyl, ethyl, propyl, i-propyl, allyl or phenyl.

11. The composition according to claim 1, wherein each Y is independently selected from halo or a (1-2C)alkyl group which is optionally substituted with halo, phenyl, or Si[(1-4C)alkyl]₃.

12. The composition according to claim 11, wherein Y is halo.

13. The composition according to claim 1, wherein X is zirconium or hafnium.

14. (canceled)

15. The composition according to claim 1, wherein the compound of formula (I) has any of formulae (II), (III) or (IV): 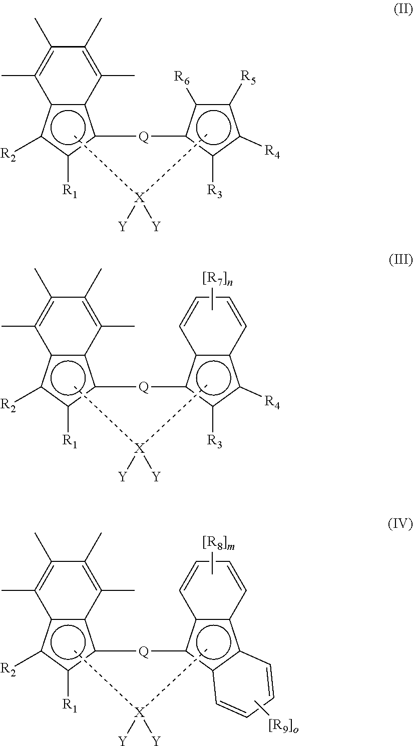
wherein:
R₁ and R₂ are each independently (1-2C)alkyl;
R₃ and R₄ are each independently hydrogen or (1-4C)alkyl, or R₃ and R₄, taken together with the atoms to which they are attached, form a 6-membered fused aromatic ring optionally substituted with one or more groups selected from the group consisting of (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
R₅ and R₆ are hydrogen;
Q is a bridging group comprising 1, 2 or 3 bridging atoms selected from the group consisting of C, N, O, S, Ge, Sn, P, B, and Si, or a combination thereof, and is optionally substituted with one or more groups selected from the group consisting of hydroxyl, (1-6C)alkyl, (2-6C)alkenyl, (2-6C)alkynyl, (1-6C)alkoxy and aryl;
X is zirconium, titanium or hafnium; and
each Y group is independently selected from the group consisting of halo, hydride, a phosphonate anion, a sulfonate anion, a borate anion, (1-6C)alkyl, (2-6C)alkenyl, (2-6C)alkynyl, (1-6C)alkoxy, aryl, and aryloxy, wherein each of (1-6C)alkyl, (2-6C)alkenyl, (2-6C)alkynyl, (1-6C)alkoxy, aryl, and aryloxy is optionally substituted with one or more groups selected from the group consisting of (1-6C)alkyl, halo, nitro, amino, phenyl, (1-6C)alkoxy, —C(O)NRₓR_{y} and Si[(1-4C)alkyl]₃;
wherein Rₓ and R_{y} are independently (1-4C)alkyl;
each R₇, R₈ and R₉ is independently selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl; and
n, m and o are independently 0, 1 or 2.

16. The composition according to claim 15, wherein each R₇, R₈ and R₉ is independently selected from (1-4C)alkyl and phenyl, said phenyl group being optionally substituted with one or more groups selected from the group consisting of hydrogen, (1-4C)alkyl, (2-4C)alkenyl, (2-4C)alkynyl, (1-4C)alkoxy, halo, amino and nitro.

17. The composition according to claim 16 wherein
each R₇, R₈ and R₉ is independently selected from hydrogen, methyl, n-butyl, tert-butyl and phenyl.

18. The composition according to claim 1, wherein the compound of formula (I) has any of formulae (V), (VI) or (VII): 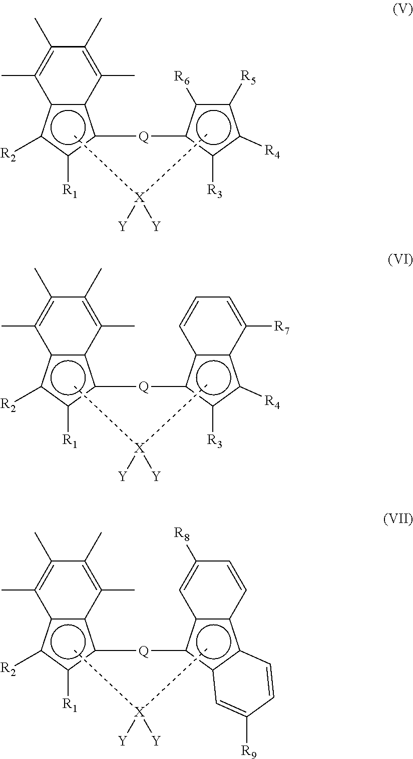
wherein
R₁ and R₂ are each independently (1-2C)alkyl;
R₃ is hydrogen or (1-4C)alkyl;
R₄ is hydrogen;
R₅ and R₆ are hydrogen or (1-4C)alkyl, or R₅ and R₆, taken together with the atoms to which they are attached, form a 6-membered fused aromatic ring optionally substituted with one or more groups selected from the group consisting of (1-6C)alkyl, (2-6C)alkenyl, (2-6C)alkynyl, (1-6C)alkoxy, aryl, heteroaryl, carbocyclic and heterocyclic, wherein each aryl, heteroaryl, carbocyclic and heterocyclic group is optionally substituted with one or more groups selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl;
Q is a bridging group comprising 1, 2 or 3 bridging atoms selected from the group consisting of C, N, O, S, Ge, Sn, P, B, and Si, or a combination thereof, and is optionally substituted with one or more groups selected from the group consisting of hydroxyl, (1-6C)alkyl, (2-6C)alkenyl, (2-6C)alkynyl, (1-6C)alkoxy and aryl;
X is zirconium, titanium or hafnium; and
each Y group is independently selected from the group consisting of halo, hydride, a phosphonate anion, a sulfonate anion, a borate anion, (1-6C)alkyl, (2-6C)alkenyl, (2-6C)alkynyl, (1-6C)alkoxy, aryl, and aryloxy, wherein each of (1-6C)alkyl, (2-6C)alkenyl, (2-6C)alkynyl, (1-6C)alkoxy, aryl, and aryloxy is optionally substituted with one or more groups selected from the group consisting of (1-6C)alkyl, halo, nitro, amino, phenyl, (1-6C)alkoxy, —C(O)NRₓR_{y} and Si[(1-4C)alkyl]₃;
wherein Rₓ and R_{y} are independently (1-4C)alkyl;
R₇, R₈ and R₉ are each independently selected from the group consisting of (1-6C)alkyl, (2-6C)alkenyl, (2-6C)alkynyl, (1-6C)alkoxy, halo, amino, nitro, cyano, (1-6C)alkylamino, [(1-6C)alkyl]₂amino and —S(O)₂(1-6C)alkyl.

19. The composition according to claim 1, where the compound of formula (I) has any one of the structures shown below:

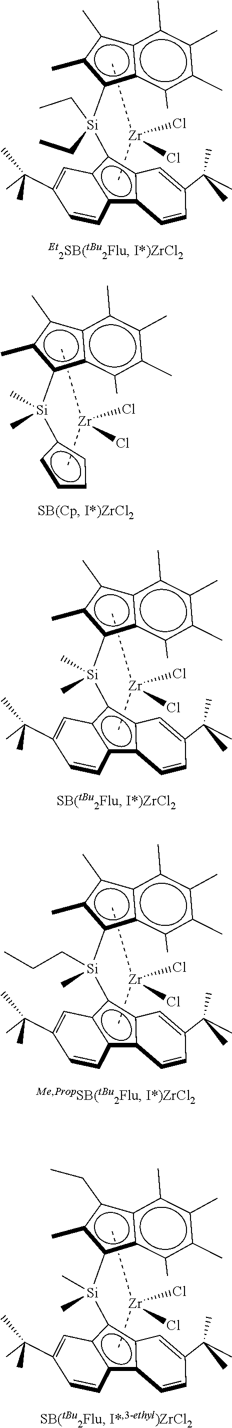

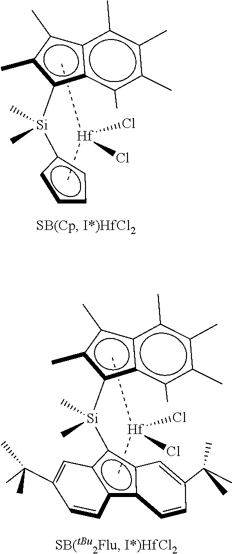

20. The composition according to claim 1, wherein the composition further comprises a suitable activator.

21. (canceled)

22. The composition according to claim 20, wherein the activator is methylaluminoxane (MAO), triisobutylaluminium (TIBA), diethylaluminium (DEAC) or triethylaluminium (TEA).

23. A process for preparing a polyolefin comprising contacting a composition as defined in claim 1 with one or more olefin monomers to provide a homopolymer or a copolymer.

24. The process according to claim 23, wherein the copolymer comprises 1-10 wt % of a (4-8C) α-olefin.

25. (canceled)

26. The process according to claim 23, wherein the process is performed at a temperature of 25-100° C.

27. (canceled)
